(19) United States
(12) Patent Application Publication
(10) Pub. No.: US 2025/0369537 A1
(43) Pub. Date: Dec. 4, 2025

(54) CABLE PROTECTION APPARATUS

(71) Applicant: Chevron U.S.A. Inc., San Ramon, CA (US)

(72) Inventors: Albert Eugene Butterfield, IV, Novato, CA (US); Brian Christopher Weber, Martinez, CA (US); Mark Allen Gracy, JR., Napa, CA (US); Mayank Malik, Houston, TX (US)

(21) Appl. No.: 18/675,907

(22) Filed: May 28, 2024

(51) Int. Cl. F16L 3/12; F16L 3/01; H02G 15/00

(52) U.S. Cl. CPC F16L 3/1211; F16L 3/01; H02G 15/00

(57) ABSTRACT

A cable protection apparatus can include a collet having a collet body and a collet bore, where the collet bore traverses through the collet body along its length, where the collet body is radially compressible along the collet length, where the collet bore has a reduced diameter when the collet body is compressed. The cable protection apparatus can also include an enclosure having an enclosure body, an enclosure bore, an enclosure channel, and an adjustment feature, where the enclosure bore traverses through the enclosure body along its length, where the enclosure channel traverses a thickness of the enclosure body to the enclosure bore along the enclosure length, where the enclosure bore traverses a receiving chamber disposed within the enclosure body, where the receiving chamber is configured to receive the collet, where the adjustment feature manipulates the enclosure body to apply a force to compress the collet body.

### TECHNICAL FIELD

The present disclosure relates generally to a cable protection apparatus, and more particularly to systems, methods, and devices for securing one or more components to a cable.

### BACKGROUND

At times, cables of sizable length (e.g., hundreds of feet, thousands of feet) have one or more components (e.g., standoffs) attached thereto to serve a function (e.g., protect the cable from sharp or course edges) with respect to the cable. For example, a wireline operation within a subterranean wellbore can involve placing a wireline tool at the end of a long wireline cable and dropping the wireline tool thousands of feet into the wellbore to collect information (e.g., measure parameters, capture images) within the wellbore. Once the information is collected, the wireline cable is pulled up to remove the wireline tool. In alternative cases, a wireline operation can involve using the wireline cable to retrieve (“fish”) a tool or component from the wellbore or place a tool or component in the wellbore. The wireline cable is often made of a semi-flexible metal material.

Since wellbores are not completely straight and vertical along their length, there are sections of the wellbore that can impose high degrees of friction on the wireline during a wireline operation as the wireline is being lowered into and/or raised out of a wellbore. When too much friction results, the wireline can degrade. In extreme cases, the wireline breaks, resulting in tremendous costs (e.g., rig time, non-use of personnel, modification of wellbore, shutting in wellbore). Within a wellbore, a wireline can get damaged against non-smooth portions of a subterranean formation, a non-smooth wall of casing, and/or a step feature in the casing. Similarly, the casing and/or subterranean formation that forms the wellbore can be damaged by a wireline during a wireline operation.

### SUMMARY

In general, in one aspect, the disclosure relates to a cable protection apparatus. The cable protection apparatus may include a collet having a collet body and a collet bore, where the collet body has a collet length, where the collet bore traverses through the collet body along the collect length, where the collet body is radially compressible along the collet length, where the collet body has a compressed state and a default state, where the collet bore has a reduced collet diameter when the collet body is in the compressed state, and where the collet bore has a default collet diameter when the collet body is in the default state. The cable protection apparatus may also include an enclosure having an enclosure body, an enclosure bore, an enclosure channel, and an adjustment feature, where the enclosure bore traverses through the enclosure body along an enclosure length, where the enclosure channel traverses a thickness of the enclosure body to the enclosure bore along the enclosure length, where the enclosure bore traverses a receiving chamber disposed within the enclosure body, where the receiving chamber is configured to receive the collet, where the adjustment feature manipulates the enclosure body between an engaged position and a disengaged position, where the enclosure body applies a compressive force via the receiving chamber sufficient to put the collet body in the compressed state when the adjustment feature is in the engaged position, and where the enclosure body fails to apply the compressive force via the receiving chamber to the collet body when the adjustment feature is in the disengaged position to allow the collet body to be in the default state.

In other aspects, the disclosure relates to a cable protection apparatus assembly. The cable protection apparatus assembly may include a cable having a cable thickness. The cable protection apparatus assembly may also include a cable protection apparatus encasing a portion of the cable. The cable protection apparatus of the cable protection apparatus assembly may include a collet having a collet body and a collet bore, where the collet body has a collet length, where the collet bore traverses through the collet body along the collect length, where the collet body is radially compressible along the collet length, where the collet body has a compressed state and a default state, where the collet bore has a reduced collet diameter that is no greater than the cable thickness when the collet body is in the compressed state, and where the collet bore has a default collet diameter that is no less than the cable thickness when the collet body is in the default state. The cable protection apparatus of the cable protection apparatus assembly may also include an enclosure having an enclosure body, an enclosure bore, an enclosure channel, and an adjustment feature, where the enclosure bore traverses through the enclosure body along an enclosure length, where the enclosure channel traverses a thickness of the enclosure body to the enclosure bore along the enclosure length, where the enclosure bore traverses a receiving chamber disposed within the enclosure body, where the receiving chamber is configured to receive the collet, where the adjustment feature manipulates the enclosure body between an engaged position and a disengaged position, where the enclosure body applies a compressive force via the receiving chamber sufficient to put the collet body in the compressed state when the adjustment feature is in the engaged position, and where the enclosure body fails to apply the compressive force via the receiving chamber to the collet body when the adjustment feature is in the disengaged position to allow the collet body to be in the default state.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a system that includes a wireline having example cable protection apparatuses according to certain example embodiments.

FIG. 2 shows a system that includes an electrical cable having example cable protection apparatuses according to certain example embodiments.

FIG. 3 through 5 show block diagrams of a cable protection apparatus according to certain example embodiments.

FIGS. 6 and 7 show block diagrams of examples of multi-piece enclosures of a cable protection apparatus according to certain example embodiments.

FIGS. 8 and 9 show block diagrams of examples of multi-piece collets for a cable protection apparatus according to certain example embodiments.

FIGS. 10A through 10C show various views of a cable protection apparatus according to certain example embodiments.

FIGS. 11A and 11B show various views of a subset of the cable protection apparatus of FIGS. 10A through 10C according to certain example embodiments.

FIGS. 12A and 12B show various views of the enclosure of the cable protection apparatus of FIGS. 10A through 10C and the subset of FIGS. 11A and 11B according to certain example embodiments.

FIGS. 13A through 13C show various views of the sleeve of the cable protection apparatus of FIGS. 10A through 11B according to certain example embodiments.

FIGS. 14A through 14E show various views of one portion of the enclosure of FIGS. 12A and 12B according to certain example embodiments.

FIGS. 15A through 15F show various views of another portion of the enclosure of FIGS. 12A and 12B according to certain example embodiments.

FIGS. 16A through 16H show various views of the collet of the cable protection apparatus of FIGS. 10A through 10C according to certain example embodiments.

FIGS. 17 through 22 show a progression of systems showing the enclosure of FIGS. 10A through 10C becoming engaged with a cable according to certain example embodiments.

FIGS. 23A through 23D show various views of an alternative collet having a single portion that may be used with the enclosure of FIGS. 12A and 12B according to certain example embodiments.

### DETAILED DESCRIPTION

In general, example embodiments provide systems, methods, and devices for cable protection apparatuses. Example embodiments can provide a number of benefits. Such benefits can include, but are not limited to, minimal interruption time of an operation (e.g., a wireline operation, a cable pulling operation), targeted protection of a cable within an environment, ease of position changes, ease of installation and uninstallation with respect to a cable, and compliance with industry standards that apply to wireline operations. While example embodiments described herein are directed for use with certain types of cables (e.g., wirelines, electrical cables), in alternative embodiments, an example cable protection apparatus may be used additionally or alternatively with other types of cables and/or wires. Also, while example embodiments described herein are directed for use in certain environments, (e.g., a wellbore environment, a building), in alternative embodiments, an example cable protection apparatus may be used in any of a number of other environments (whether hazardous, maritime, or otherwise) in which a cable or wire can use targeted protection from damage caused by portions of such other environments.

In addition, or in the alternative, example embodiments may be used to help protect parts of a structure (e.g., the casing and/or formation wall of a wellbore, studs and other supports of a building) from friction generated by a cable. As defined herein, a user may be any person that interacts with a cable or associated cable operation. Examples of a user may include, but are not limited to, a drilling engineer, a wireline engineer, an electrician, a roughneck, a company representative, a mechanic, an operator, an employee, a consultant, a contractor, and a manufacturer's representative.

Example cable protection apparatuses can be made of one or more of a number of suitable materials to allow the cable protection apparatuses to meet certain standards and/or regulations while also maintaining durability in light of the one or more conditions under which the cable protection apparatuses, including components thereof, may be exposed. Examples of such materials can include, but are not limited to, aluminum, stainless steel, fiberglass, glass, plastic (e.g., polytetrafluoroethylene (PTFE), nylon), a polymer (e.g., an acetal homopolymer, a copolymer of terephthalic acid (1,4) and ethylene glycol), ceramic, and rubber.

Example cable protection apparatuses, or portions or components thereof, described herein can be made from a single piece (e.g., from a mold, using injection molding, using a die cast process, using a milling and/or lathing process, using an extrusion process, 3D printing). In addition, or in the alternative, example cable protection apparatuses (including portions or components thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, rotatably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of an example cable protection apparatus to become coupled, directly or indirectly, to one or more other components of the cable protection apparatus and/or to a cable. A coupling feature can include, but is not limited to, a clamp, a portion of a hinge, a channel, an aperture, a recessed area, a protrusion, a hole or other type of aperture, a slot, a tab, a detent, and mating threads. One portion of an example cable protection apparatus can be coupled to another component or feature of the cable protection apparatus and/or to a cable by the direct use of one or more coupling features.

In addition, or in the alternative, a portion of an example cable protection apparatus can be coupled to another component or feature of the cable protection apparatus and/or to a cable using one or more independent devices that interact with one or more coupling features disposed on a component or feature of the cable protection apparatus. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

The use of the terms “substantially”, “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, an angle that is substantially perpendicular may be construed to be within a range from 81° to 99°. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subterranean formation” refers to practically any volume under a surface. For example, it may be practically any volume under a terrestrial surface (e.g., a land surface), practically any volume under a seafloor, etc. Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to: shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subterranean formation” is not limited to any description or configuration described herein.

A “well” or a “wellbore” refers to a single hole, usually cylindrical, that is drilled into a subsurface volume of interest. A well or a wellbore may be drilled in one or more directions. For example, a well or a wellbore may include a vertical well, a horizontal well, a deviated well, and/or other type of well. A well or a wellbore may be drilled in the subterranean formation for exploration and/or recovery of resources. A plurality of wells (e.g., tens to hundreds of wells) or a plurality of wellbores are often used in a field depending on the desired outcome.

A well or a wellbore may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the subterranean formation, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well.

In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well can on occasion use wireline services for wellbore evaluation (“logging”), equipment retrieval (“fishing”), conveyance of downhole tools, and the like. A well may also include any completion hardware that is not discussed separately. The term “well” may be used synonymously with the terms “borehole,” “wellbore,” or “well bore.” The term “well” is not limited to any description or configuration described herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A.

In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C.

In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C).

In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

In the foregoing figures showing example embodiments of cable protection apparatuses, one or more of the components shown may be omitted, repeated, and/or substituted. Accordingly, example embodiments of cable protection apparatuses should not be considered limited to the specific arrangements of components shown in any of the figures. For example, features shown in one or more figures or described with respect to one embodiment can be applied to another embodiment associated with a different figure or description.

In certain example embodiments, cable systems using example cable protection apparatuses are subject to meeting certain standards and/or requirements. Examples of entities that set such standards and/or requirements can include, but are not limited to, the Society of Petroleum Engineers, the American Petroleum Institute (API), the International Standards Organization (ISO), the National Institute of Standards and Technology (NIST), and the Occupational Safety and Health Administration (OSHA). Use of example embodiments described herein meet (and/or allow the wireline systems to meet) such standards and/or requirements when applicable.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of cable protection apparatuses will be described more fully hereinafter with reference to the accompanying drawings, in which example embodiments of cable protection apparatuses are shown. Cable protection apparatuses may, however, be embodied in many different forms and should not be construed as limited to the example embodiments set forth herein. Rather, these example embodiments are provided so that this disclosure will be thorough and complete, and will fully convey the scope of cable protection apparatuses to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of cable protection apparatuses. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

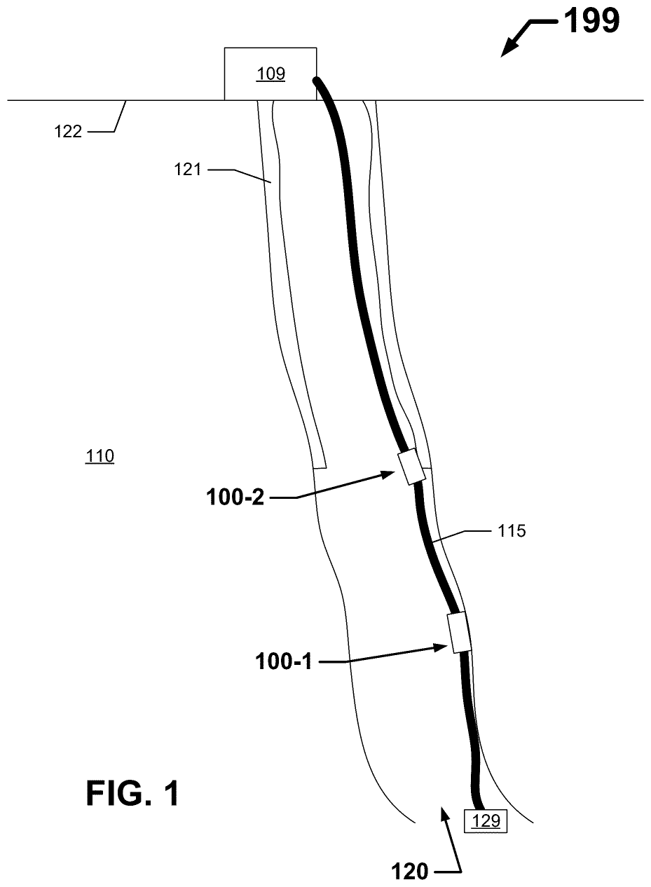

FIG. 1 shows a system 199 that includes a cable 115 having example cable protection apparatuses 100 according to certain example embodiments. Specifically, FIG. 1 shows a diagram of a land-based system 199 in which a wellbore 120 has been drilled or is being drilled in a subterranean formation 110 and in which example embodiments can be used. The wireline system 199 of FIG. 1 includes a wellbore 120 disposed in a subterranean formation 110 that was drilled using field equipment that includes, but is not limited to, a derrick, a tool pusher, a clamp, a tong, drill pipe, casing pipe, a drill bit, a wireline tool 129, a fluid pumping system, a motor, a variable frequency drive, and a compressor.

As the depth of the wellbore 120 increases, one or more casing strings 121 may be inserted into the wellbore 120 from the surface 122 and subsequently cemented to the wellbore 120 to stabilize the wellbore 120 and allow for the extraction of subterranean resources (e.g., oil, natural gas) from the subterranean formation 110. The casing string 121 may be a number of pipes that are connected end-to-end using coupling features (e.g., mating threads) and/or another coupling component (e.g., a sub, a collar). A wellbore 120 may undergo multiple casing and cementing operations, where each casing and cementing operation covers part or all of a segment of the wellbore 120 or multiple segments of the wellbore 120. In such a case, the wellbore 120 can have a casing program using multiple casing strings 121 at different depths within the wellbore 120.

Each casing pipe of the casing string 121 can have a length and a width (e.g., outer diameter). The length of a casing pipe can vary. For example, a common length of a casing pipe is approximately 40 feet. The length of a casing pipe can be longer (e.g., 60 feet) or shorter (e.g., 10 feet) than 40 feet. The width of a casing pipe can also vary and can depend on the cross-sectional shape of the casing pipe. For example, when the cross-sectional shape of a casing pipe is circular, which is commonly the case, the width can refer to an outer diameter, an inner diameter, or some other form of measurement of the casing pipe. Examples of a width in terms of an outer diameter of a casing pipe can include, but are not limited to, 4-½ inches, 7 inches, 7-⅝ inches, 8-⅝ inches, 10-¾ inches, 13-⅜ inches, 14 inches, and 30 inches. Under a casing program, the larger widths of the casing pipe are closer to the entry point at the surface 122, and the width gradually decreases by segment moving toward the distal end of the wellbore 120.

The size (e.g., width, length) of the casing string 121 can be based on the information gathered using some of the field equipment with respect to the subterranean wellbore 120. The walls of the casing string 121 have an inner surface that forms a cavity that traverses the length of the casing string 121. Each casing pipe of the casing string 121 can be made of one or more of a number of suitable materials, including but not limited to stainless steel. As discussed above, there is a gap, also called an annulus, between the outer surface of the casing string 121 and the wall of the wellbore 120. This gap is filled with cement at times. In some cases, stabilizers (not shown) or similar devices can be inserted along with the casing pipes and/or integrated with the casing pipe. These stabilizers help to keep the casing string 121 relatively centered within the wellbore 120.

The surface 122 can be ground level for an on-shore (also called land-based) application (as in this case) and the sea floor or seabed for an off-shore application. The point where the wellbore 120 begins at the surface 122 can be called the entry point. While not shown in FIG. 1, there can be multiple wellbores 120, each with its own entry point but that is located close to the other entry points, drilled into the subterranean formation 110. In such a case, the multiple wellbores 120 can be drilled at the same pad location.

The subterranean formation 110 can include one or more of a number of formation types, including but not limited to shale, limestone, sandstone, clay, sand, and salt. In certain embodiments, a subterranean formation 110 can include one or more reservoirs in which one or more subterranean resources (e.g., oil, gas, water, steam) can be located. One or more of a number of field operations (e.g., wireline, fracturing, coring, tripping, drilling, setting casing, extracting downhole resources) can be performed to reach an objective of a user with respect to the subterranean formation 110.

The wellbore 120 can have one or more of a number of segments, where each segment can have one or more of a number of dimensions. Examples of such dimensions can include, but are not limited to, size (e.g., diameter) of the wellbore 120, a curvature of the wellbore 120, a true vertical depth of the wellbore 120, a measured depth of the wellbore 120, and a horizontal displacement of the wellbore 120. A wellbore 120 can have one or more vertical (or substantially vertical) sections and/or one or more horizontal (or substantially horizontal) sections.

At the point in time captured in FIG. 1, a wireline operation is being performed on the wellbore 120. Specifically, wireline equipment 109 located at the surface 122 near the entry point is used to lower and subsequently raise a cable 115 in the form of a wireline into the wellbore 120. The cable 115 may be a flexible metal cable (e.g., a slickline cable, an electrical cable, a braided metal cable) used for well completion and/or intervention operations (e.g., fishing, conveyance of downhole tools, logging). The cable 115 may have a thickness (e.g., a diameter) that is substantially constant or variable along its length. At the distal end of the cable 115 may be one or more wireline tools 129. Examples of such wireline tools 129 may include, but are not limited to, natural gamma ray tools, nuclear tools, resistivity tools, sonic tools, ultrasonic tools, nuclear magnetic resonance tools, borehole seismic tools, and cased hole electric line tools.

As the cable 115 is lowered into the wellbore 120 and subsequently removed from the wellbore 120 by the wireline equipment 109, the cable 115 may be exposed to sharp edges and/or rough surfaces within the wellbore 120, whether from the casing string 121 or the subterranean formation 110. As a result of such interactions, the cable 115 may become damaged or, in the worst case, severed or inoperable. Aside from the high cost of replacing and/or repairing the cable 115, further retrieval from the wellbore 120 resulting from a severed cable 115 and/or damage to the wireline tool 129 can add significant time and expense to a project.

In addition, or in the alternative, as the cable 115 is lowered into the wellbore 120 and subsequently removed from the wellbore 120 by the wireline equipment 109, the cable 115 may cause damage (e.g., generating rough surfaces, causing pitting, causing erosion) to the casing string 121 and/or to the wall of the wellbore 120 formed by the subterranean formation 110. Such damage to the casing string 121 and/or the subterranean formation 110 at the wellbore 120 may lead to damage of the cable 115, to damage of other equipment used in the wellbore 120, and/or to delays and/or prohibition of subsequent subterranean field operations with respect to the wellbore 120.

In order to avoid or minimize the risk of the cable 115, the casing string 121, and/or the wall of the subterranean formation 110 forming the wellbore 120 being damaged from interactions within the wellbore 120 during a wireline operation, example cable protection apparatuses 100 may be used. Any number (e.g., one, 5, 40, 100, 250) of cable protection apparatuses 100 may be used in a wireline operation. In this case, there are two cable protection apparatuses 100 in use as of the point in time during the wireline operation of the wireline system 199 captured in FIG. 1. Cable protection apparatus 100-1 encompasses a lengthwise portion of the cable 115 approximately halfway between the bottom of the casing string 121 and the bottom of the wellbore 120, and cable protection apparatus 100-2 encompasses a lengthwise portion of the cable 115 approximately at the bottom of the casing string 121.

As the cable 115 is lowered into the wellbore 120 by the wireline equipment 109, the process may be momentarily paused from time to time in order to install an example cable protection apparatus 100 on a lengthwise section of the cable 115. In some cases, a cable protection apparatus 100 may be installed on the cable 115 with little or no delay or slowing in lowering the cable 115 into the wellbore 120. Similarly, as the cable 115 is removed from the wellbore 120 by the wireline equipment 109, the process may be momentarily paused from time to time in order to remove an example cable protection apparatus 100 from a lengthwise section of the cable 115. In some cases, a cable protection apparatus 100 may be removed from the cable 115 with little or no delay or slowing in extracting the cable 115 from the wellbore 120.

In certain example embodiments, each example cable protection apparatus 100 is configured to be engaged with the cable 115 in a relatively minimal amount of time. For example, an example cable protection apparatus 100 may be engaged with the cable 115 without the use of tools. As a result, there are minimal disruptions to the wireline operations as the cable 115 is lowered into the wellbore 120. Similarly, each example cable protection apparatus 100 may be configured to be disengaged (e.g., without the use of tools) from the cable 115 in a relatively minimal amount of time. When a wireline system (e.g., wireline system 199) includes multiple example cable protection apparatuses 100, as in this case, the configuration (e.g., number of parts, shape of each part, size of each part, configuration of coupling features) of one cable protection apparatus 100 can be the same as, or different than, the configuration of one or more of the other cable protection apparatuses 100. Each example cable protection apparatus 100 is configured to absorb impacts of the wellbore 120 (e.g., the casing string 121, the subterranean formation 110) to protect the portion of the cable 115 encased by the cable protection apparatus 100 from wear.

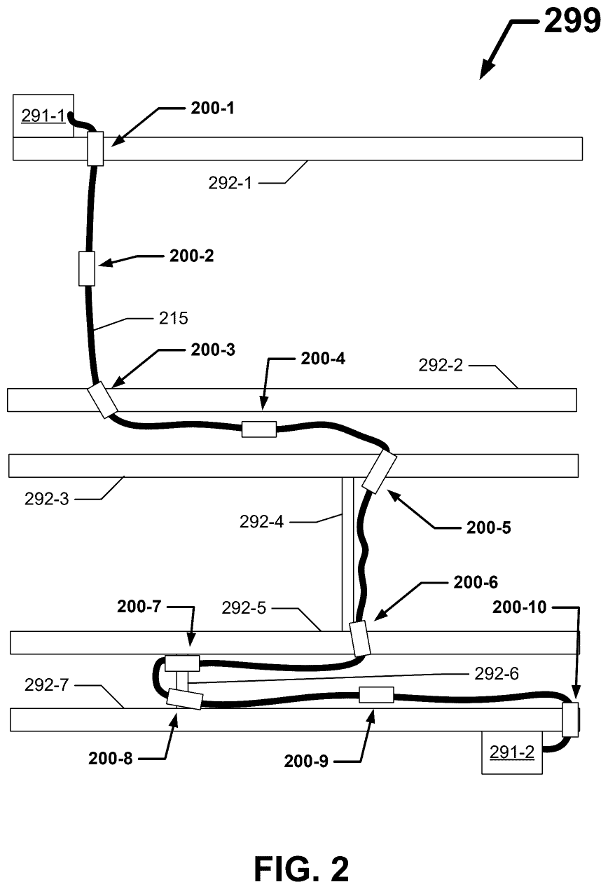

FIG. 2 shows another system 299 that includes a cable 215 having example cable protection apparatuses 200 according to certain example embodiments. In this case, the system 299 includes a building structure having a number of supports 292 (e.g., studs, girders). The cable 215 in this case is in the form of an electrical cable that runs from a junction box 291-1 toward a top end of the structure and another junction box 291-2 toward the bottom end of the structure. For the cable 215 to be put in place as shown in FIG. 2, the cable 215 must be pulled near or through holes in the various supports 292 of the structure. In this case, the cable 215 is pulled through or near, from top to bottom, support 292-1, support 292-2, support 292-3, support 292-4, support 292-5, support 292-6, and support 292-7.

To help ensure that the cable 215 is not worn or damaged as it is pulled through or near the support 292 in the system 299, multiple example cable protection apparatuses 200 are installed at various points along the length of the cable 215. In this example, there are nine cable protection apparatuses 200 (cable protection apparatus 200-1, cable protection apparatus 200-2, cable protection apparatus 200-3, cable protection apparatus 200-4, cable protection apparatus 200-5, cable protection apparatus 200-6, and cable protection apparatus 200-7) are installed along various intervals (e.g., every 10 feet, randomly) of the cable 215.

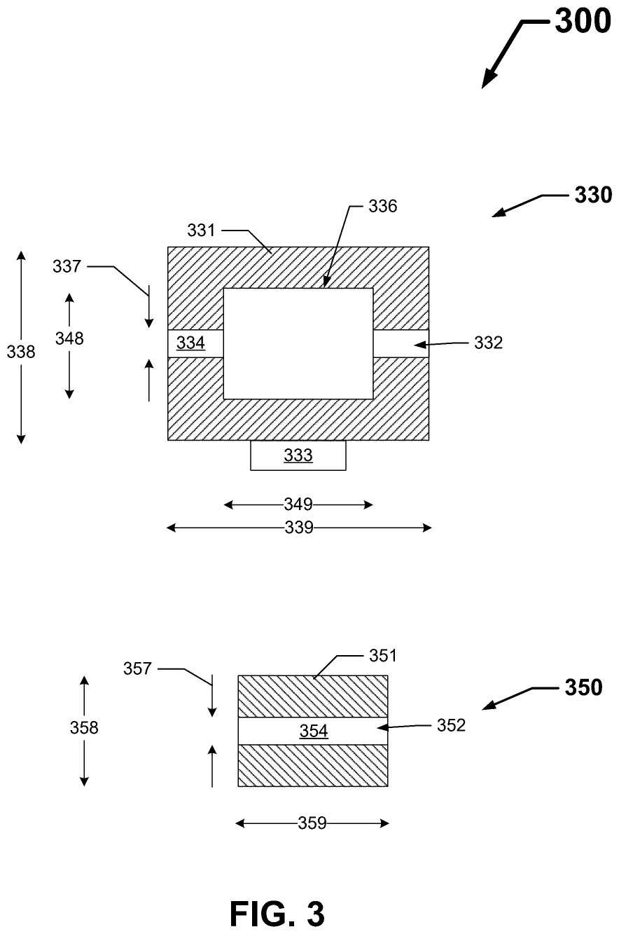

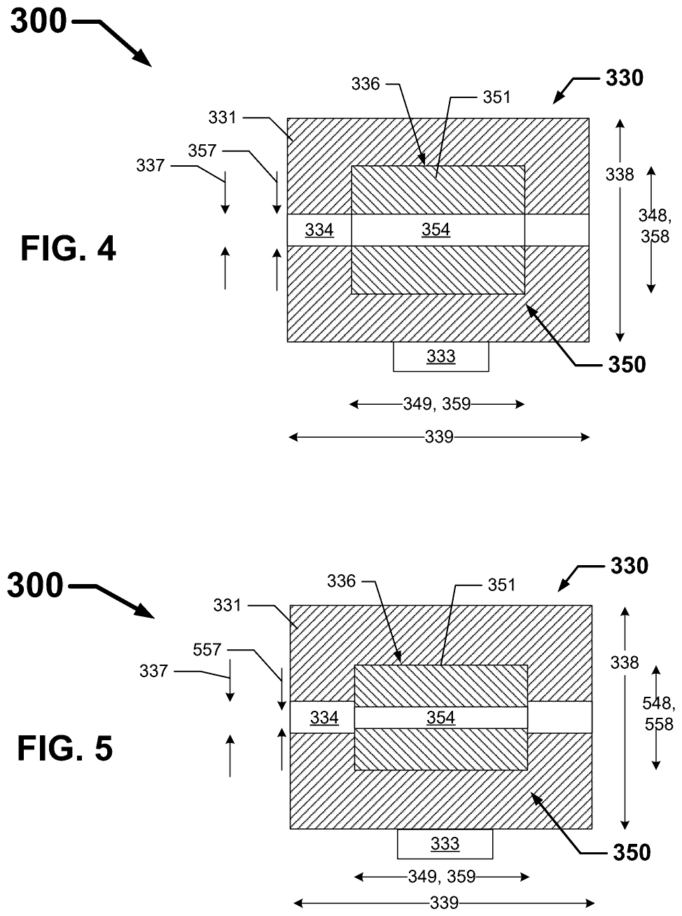

FIG. 3 through 5 show block diagrams of a cable protection apparatus 300 according to certain example embodiments. Specifically, FIG. 3 shows a block diagram of the cable protection apparatus 300 with the enclosure 330 and the collet 350 separated from each other. FIG. 4 shows a block diagram of the cable protection apparatus 300 with the collet 350 nested within the enclosure 330 when the enclosure is in the disengaged position. FIG. 5 shows a block diagram of the cable protection apparatus 300 with the collet 350 nested within the enclosure 330 when the enclosure is in the engaged position.

Referring to the description of FIGS. 1 and 2 above, the collet 350 of the cable protection apparatus 300 includes a body 351 and a bore 354. The body 351 (sometimes referred to herein as a collet body 351) has a length 359 (sometimes referred to herein as a collet length 359) and a height 358 (sometimes referred to herein as a collet height 358). The bore 354 (sometimes referred to herein as a collet bore 354) traverses through the body 351 along the length 359. Also, the bore 354 has a height 357 (e.g., a diameter when the bore 354 has a circular cross-sectional shape) (sometimes referred to herein as a collet height 357).

In certain example embodiments, the body 351 of the collet 350 is radially compressible along the length 359 of the collet 350. In such cases, the body 351 of the collet 350 may have a compressed state (as shown in FIG. 5) and a default state (as shown in FIGS. 3 and 4). When the collet 350 is in the default state, the bore 354 of the collet 350 has the height 357, and the body 351 of the collet 350 has the height 358. By contrast, when the collet 350 is in the compressed state, the body 351 of the collet 350 has the height 558 that is less than (reduced relative to) the height 358.

Also, when the collet 350 is in the compressed state, the bore 354 of the collet 350 has the height 557 (also sometimes called a compressed height 557) (e.g., 0.25 inches, 0.4 inches, 0.75 inches, 1.25 inches, 2 inches) that is less than (reduced relative to) the height 357 (also sometimes called a default height 357). When the collet 350 is in the compressed state, the cross-sectional shape of the bore 354 may be the same as, or different than, the cross-sectional shape of the bore 354 when the collet 350 is in the default state. The cross-sectional shape of the bore 354 when the collet 350 is in the compressed state may be determined by how the enclosure applies a compressive force to the collet 350.

In some cases, the collet 350 has a channel 352 that traverses the length 359 of the collet 350 between the outer perimeter of the body 351 and the bore 354. The channel 352 is configured to allow a cable (e.g., cable 115, cable 215) to pass therethrough to be placed in and/or to be removed from the bore 354. When present, the channel 352 of the collet 350 may have the same height 357 (also sometimes called a width) (e.g., 0.5 inches, 1 inch, 2 inches, 3 inches) as the bore 354 of the collet 350. Alternatively, the channel 352 of the collet 350 may have a width that is greater than or less than the height 357 of the bore 354. In some cases, the width of the channel 352 may be variable or fall within a range between the outer perimeter of the body 351 and the bore 354.

The enclosure 330 of the cable protection apparatus 300 includes a body 331 and a bore 334. The body 331 (sometimes referred to herein as an enclosure body 331) has a length 339 (sometimes referred to herein as an enclosure length 339) (e.g., 2 inches, 3 inches, 4 inches, 6 inches) and a height 338 (sometimes referred to herein as an enclosure height 338) (e.g., 1 inch, 2 inches, 2.5 inches, 3 inches). The bore 334 (sometimes referred to herein as an enclosure bore 334) traverses through the body 331 along the length 339. Also, the bore 334 has a height 337 (e.g., a diameter when the bore 334 has a circular cross-sectional shape) (sometimes referred to herein as an enclosure bore height 337) (e.g., 0.5 inches, 1 inch, 2 inches, 3 inches).

The enclosure 330 also has a channel 332 (sometimes referred to as an enclosure channel 332 herein) that traverses the length 339 of the enclosure 330 between the outer perimeter of the body 331 and the bore 334, which represents the thickness of the body 331. The channel 332 is configured to allow a cable (e.g., cable 115, cable 215) to pass therethrough to be placed in and/or to be removed from the bore 334. When present, the channel 332 of the enclosure 330 may have the same height 337 (also sometimes called a width) (e.g., 0.5 inches, 1 inch, 2 inches, 3 inches) as the bore 334 of the enclosure 330. Alternatively, the channel 332 of the collet 350 may have a width that is greater than or less than the height 337 of the bore 334. In some cases, the width of the channel 332 may be variable or fall within a range between the outer perimeter of the body 331 and the bore 334.

In certain example embodiments, coincident with part of the channel 332 and the bore 334 of the enclosure 330, a receiving chamber 336 is positioned within the body 331 of the enclosure 330. In other words, part of the bore 334 and, in some cases, part of the channel 332 traverse the receiving chamber 336 disposed within the body 331 of the enclosure 330. The receiving chamber 336 of the enclosure 330 is configured to receive the collet 350. As such, the receiving chamber 336 may have a shape and size that is sufficient to receive the collet 350 when the enclosure 330 is in the disengaged position. For example, the receiving chamber 336 may have a length 349 (e.g., 1 inch, 2 inches) and a height 348 (e.g., 0.5 inches, 1 inch, 1.5 inches) that is at least as great as the length 359 (e.g., 0.5 inches, 0.75 inches, 1 inch, 2 inches) and the height 358 (0.25 inches, 0.4 inches, 0.5 inches, 1 inch, 1.5 inches), respectively, of the collet 350.

In certain example embodiments, the body 331 of the enclosure 330 has an engaged position (as shown in FIG. 5) and a disengaged position (as shown in FIGS. 3 and 4). The enclosure 330 may include an adjustment feature 333 to manipulate the body 331 of the enclosure 330 between the engaged position and the disengaged position. In the disengaged position, the body 331 of the enclosure 330 is configured in such a way that the receiving chamber 336 has a shape and size sufficient to receive the collet 350 in the default state. As a result, the body 331 of the enclosure 330 fails to apply a compressive force via the receiving chamber 336 to the body 351 of the collet 350 when the adjustment feature 333 is in the disengaged position, which allows the body 351 of the collet 350 to be in the default state.

By contrast, when the body 331 of the enclosure 330 is in the engaged position, the shape and/or size of the body 331 (and so also the receiving chamber 336) of the enclosure 330 is reduced relative to the shape and/or size of the body 331 (and so also the receiving chamber 336) in the disengaged position. As a result, the body 331 of the enclosure 330, when in the engaged position and with the collet 350 positioned in the receiving chamber 336, applies a compressive force via the receiving chamber 336 sufficient to put the body 351 of the collet 350 in a compressed state. In other words, when the body 331 of the enclosure 330 is in the engaged position, the shape and/or size of the body 351 of the collet 350 is reduced. When the adjustment feature 333 is actuated, the body 331 of the enclosure 330 puts and retains the body 331 of the enclosure 330 in the engaged position.

As an example, when the adjustment feature 333 is actuated and the body 331 of the enclosure 330 is in the engaged position, the height 548 of the receiving chamber 336 is reduced relative to the height 348 of the receiving chamber 336 when the adjustment feature 333 is not actuated and the body 331 of the enclosure 330 is in the disengaged position. As a result, the body 331 of the enclosure 330 applies a compressive force to the collet 350, which reduces the height 558 of the body 351 of the collet 350 relative to the height 358 of the body 351 of the collet 350 in the default state.

In addition, or in the alternative, when the body 331 of the enclosure 330 applies a compressive force to the collet 350, the height 557 (e.g., diameter) of the bore 354 of the collet 350 is reduced relative to the height 357 of the bore 354 of the collet 350 in the default state. When the body 331 of the enclosure 330 is in the engaged position, other aspects (e.g., the height 338, the depth of the bore 334, the cross-sectional shape of the bore 334) of the enclosure 330 may change relative to those aspects when the body 331 of the enclosure 330 is in the disengaged position.

The adjustment feature 333 of the enclosure 330 may have one or more of any of a number of forms. For example, when the body 331 of the enclosure is a single portion with some flexibility (e.g., malleability), the adjustment feature 333, when actuated, may cause the body 331 to change its shape and/or size and hold that deformed position until the adjustment feature 333 is no longer actuated. In such a case, examples of such an adjustment feature may include, but is not limited to, a strap with a ratcheting system, a lever with a cam operator, and a clamp.

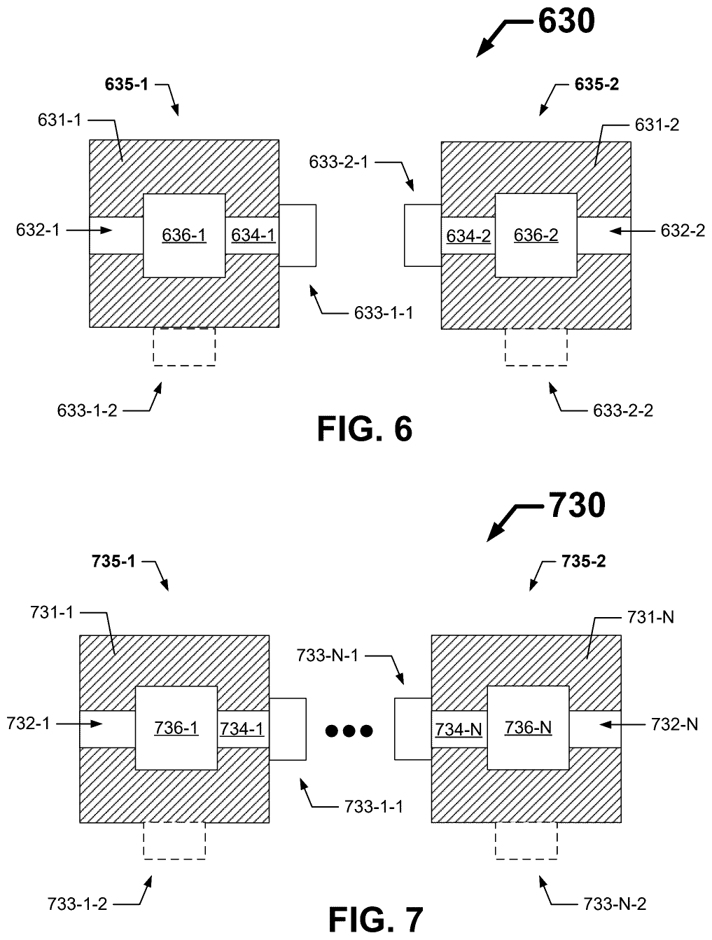

The enclosure 330 may include a single adjustment feature 333 or multiple adjustment features 333. An adjustment feature 333 may be integrated with the body 331 of the enclosure 330. In addition, or in the alternative, an adjustment feature 333 may be a separate piece relative to the body 331 of the enclosure 330. In some cases, an adjustment feature 333 may have multiple parts. For example, when the body 331 of the enclosure 330 may have multiple portions (as discussed below with respect to FIGS. 6 and 7), where one portion is movable relative to another portion, an adjustment feature 333 may have multiple parts, wherein one part of the adjustment feature 333 is integrated with one portion of the body 331 and another portion of the adjustment feature 333 is integrated with another portion of the body 331. FIGS. 6 and 7 show block diagrams of examples of multi-portion enclosures of a cable protection apparatus according to certain example embodiments. Specifically, FIG. 6 shows a block diagram of an enclosure 630 having two portions 635. FIG. 7 shows a block diagram of an enclosure 730 having N portions 735. Referring to the description above with respect to FIGS. 1 through 5, the various characteristics (e.g., the body 631, the bore 634, the channel 632, the receiving chamber 636, the adjustment features 633), including portions thereof, of the enclosure 630 of FIG. 6 and the various characteristics (e.g., the body 731, the bore 734, the channel 732, the receiving chamber 736, the adjustment features 733), including portions thereof, of the enclosure 730 of FIG. 7 are substantially the same as the corresponding characteristics of the enclosure 330 discussed above.

With respect to FIG. 6, the two portions 635 (portion 635-1 and portion 635-2) of the enclosure 630 are shown as individual pieces that are separated from each other. When the portions 635 are separated from each other, each portion 635 has part, but not the whole, of the various characteristics of the entire enclosure 630. For example, portion 635-1 of the enclosure 630 of FIG. 6 includes a part of the body 631-1, a part of the bore 634-1 that traverses through the part of the body 631-1, a part of the channel 632-1, a part of the receiving chamber 636-1, and a part of each of the adjustment features 633-1 (e.g., a part of adjustment feature 633-1-1, a part of optional adjustment feature 633-1-2). As another example, portion 635-2 of the enclosure 630 of FIG. 6 includes a part of the body 631-2, a part of the bore 634-2 that traverses through the part of the body 631-2, a part of the channel 632-2, a part of the receiving chamber 636-2, and a part of each of the adjustment features 633-2 (e.g., a part of adjustment feature 633-2-1, a part of optional adjustment feature 633-2-2).

When the two portions 635 are coupled to each other to form a single piece, the various parts of each component of the enclosure 630 form the whole of the components. For example, the part of the bore 634-1 of portion 635-1 and the part of the bore 634-2 of portion 635-2 form the entire bore 634 when portion 635-1 and portion 635-2 are coupled to each other. As another example, the part of the receiving chamber 636-1 of portion 635-1 and the part of the receiving chamber 636-2 of portion 635-2 form the entire receiving chamber 636 when portion 635-1 and portion 635-2 are coupled to each other.

In view of the above, portion 635-1 and portion 635-2 are configured to complement each other. The location, configuration, size, and/or other characteristics of the part of each adjustment feature 633 (e.g., part of adjustment feature 633-1-1, part of adjustment feature 633-2-1) of a portion 635 of the enclosure 630 may be based on one or more of a number of factors, including but not limited to the number of portions 635, the relative shape of adjacent portions 635, the relative size of adjacent portions 635, and the shape and/or size of the collet (e.g., collet 350).

In some cases, an adjustment feature 633 of the enclosure 630 may serve a dual function when the enclosure 630 has two portions 635. For example, in addition to manipulating the body 631 of the enclosure 630 between the engaged position and the disengaged position, an adjustment feature 633 may be used to couple the two portions 635 of the enclosure 630 to each other. In some cases, when an enclosure 630 has two adjustment features 633, one adjustment feature 633 (e.g., adjustment feature 633-1) or one pair of adjustment features 633 (e.g., adjustment feature 633-1-1 and adjustment feature 633-2-1) may be used for some purpose (e.g., coupling together portion 635-1 and portion 635-2 to each other), while the other adjustment feature 633 (e.g., adjustment feature 633-2) or one pair of adjustment features 633 (e.g., adjustment feature 633-1-2 and adjustment feature 633-2-2) may be used for manipulating the body 631 of the enclosure 630 between the engaged position and the disengaged position.

With respect to FIG. 7, there are N portions 735 (portion 735-1 through portion 735-N) of the enclosure 730. In this case, the N portions 735 are shown as individual pieces that are separated from each other. When the portions 735 are separated from each other, each portion 735 has part, but not the whole, of the various characteristics of the entire enclosure 730. For example, portion 735-1 of the enclosure 730 of FIG. 7 includes a part of the body 731-1, a part of the bore 734-1 that traverses through the part of the body 731-1, a part of the channel 732-1, a part of the receiving chamber 736-1, and a part of each of the adjustment features 733-1 (e.g., a part of adjustment feature 733-1-1, a part of optional adjustment feature 733-1-2). As another example, portion 735-N of the enclosure 730 of FIG. 7 includes a part of the body 731-N, a part of the bore 734-N that traverses through the part of the body 731-N, a part of the channel 732-N, a part of the receiving chamber 736-N, and a part of each of the adjustment features 733-N (e.g., a part of adjustment feature 733-N-1, a part of optional adjustment feature 733-N-2).

When the N portions 735 are coupled to each other to form a single piece, the various parts of each component of the enclosure 730 form the whole of the components. For example, the part of the bore 734-1 of portion 735-1 through the part of the bore 734-N of portion 735-N form the entire bore 734 when portion 735-1 through portion 735-N are coupled to each other. As another example, the part of the receiving chamber 736-1 of portion 735-1 and the part of the receiving chamber 736-2 of portion 735-2 form the entire receiving chamber 736 when portion 735-1 and portion 735-2 are coupled to each other.

In view of the above, portion 735-1 through portion 735-N are configured to complement each other. The location, configuration, size, and/or other characteristics of the part of each adjustment feature 733 (e.g., part of adjustment feature 733-1-1, part of adjustment feature 733-N-2) of a portion 735 of the enclosure 730 may be based on one or more of a number of factors, including but not limited to the number of portions 735, the relative shape of adjacent portions 735, the relative size of adjacent portions 735, and the shape and/or size of the collet (e.g., collet 350).

In some cases, an adjustment feature 733 of the enclosure 730 may serve a dual function when the enclosure 730 has two or more portions 735. For example, in addition to manipulating the body 731 of the enclosure 730 between the engaged position and the disengaged position, an adjustment feature 733 may be used to couple two or more portions 735 of the enclosure 730 to each other. In some cases, when an enclosure 730 has two or more adjustment features 733, one adjustment feature 733 (e.g., adjustment feature 733-1) or one pair of adjustment features 733 (e.g., adjustment feature 733-1-1 and adjustment feature 733-N-1) may be used for some purpose (e.g., coupling together portion 735-1 and portion 735-N to each other), while another adjustment feature 733 (e.g., adjustment feature 733-2) or one pair of adjustment features 733 (e.g., adjustment feature 733-1-2 and adjustment feature 733-N-2) may be used for manipulating the body 731 of the enclosure 730 between the engaged position and the disengaged position.

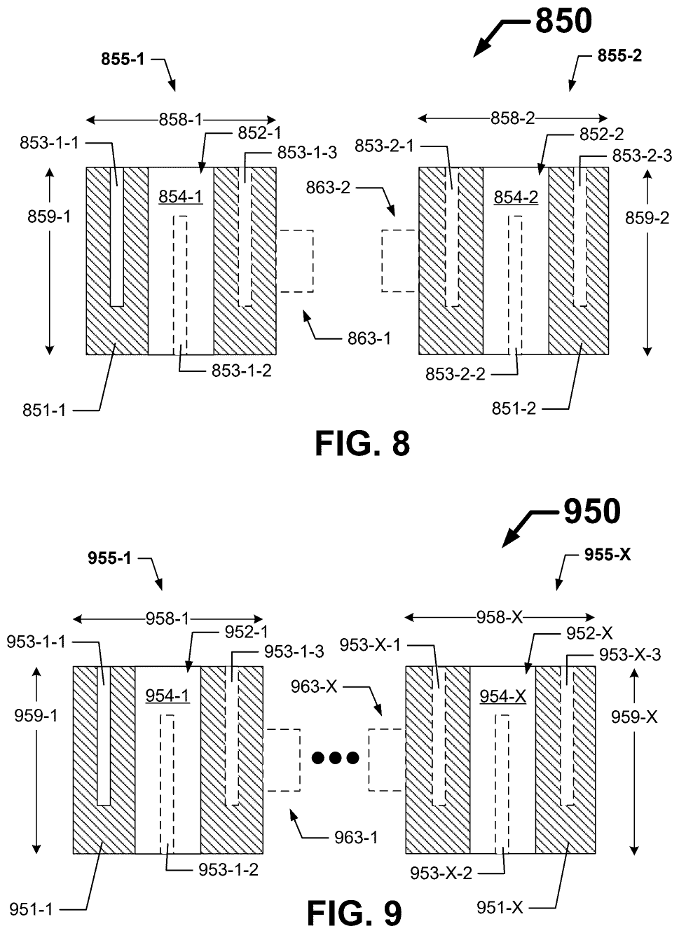

FIGS. 8 and 9 show block diagrams of examples of multi-piece collets for a cable protection apparatus according to certain example embodiments. Specifically, FIG. 8 shows a block diagram of a collet 850 having two portions 855. FIG. 9 shows a block diagram of a collet 950 having X portions 955. Referring to the description above with respect to FIGS. 1 through 7, the various characteristics (e.g., the body 851, the bore 854, the channel 852), including portions thereof, of the collet 850 of FIG. 8 and the various characteristics (e.g., the body 951, the bore 954, the channel 952), including portions thereof, of the collet 950 of FIG. 9 are substantially the same as the corresponding characteristics of the collet 350 discussed above.

With respect to FIG. 8, the two portions 855 (portion 855-1 and portion 855-2) of the collet 850 are shown as individual pieces that are separated from each other. When the portions 855 are separated from each other, each portion 855 has part, but not the whole, of the various characteristics of the entire collet 850. For example, portion 855-1 of the collet 850 of FIG. 8 includes a part of the body 851-1, a part of the bore 854-1 that traverses through the part of the body 851-1, and a part of the channel 852-1. As another example, portion 855-2 of the collet 850 of FIG. 8 includes a part of the body 851-2, a part of the bore 854-2 that traverses through the part of the body 851-2, and a part of the channel 852-2.

When the two portions 855 are coupled to each other to form a single piece, the various parts of each component of the collet 850 form the whole of the components. For example, the part of the bore 854-1 of portion 855-1 and the part of the bore 854-2 of portion 855-2 form the entire (collective) bore 854 when portion 855-1 and portion 855-2 are coupled to each other. As another example, the part of the body 851-1 of portion 855-1 and the part of the body 851-2 of portion 855-2 form the entire (collective) body 851 when portion 855-1 and portion 855-2 are coupled to each other.

In view of the above, portion 855-1 and portion 855-2 are configured to complement each other. The location, configuration, size, and/or other characteristics of the part of the body 851 (e.g., part of the body 851-1, part of the body 851-2) of a portion 855 of the collet 850 may be based on one or more of a number of factors, including but not limited to the number of portions 855, the relative shape of adjacent portions 855, the relative size of adjacent portions 855 (e.g., the width 858-1 of portion 855-1, the width 858-2 of portion 855-2), and the shape and/or size of the receiving chamber (e.g., receiving chamber 336).

In some cases, portion 855-1 and portion 855-2 are coupled to each other to form the collet 850. In such cases, portion 855-1 may include one or more coupling features 863-1, and portion 855-2 may include one or more coupling features 863-2 that complement the coupling features 863-1 of portion 855-1. Alternatively, portion 855-1 and portion 855-2 may be pieced together by abutting adjacent surfaces to form the collet 850 without the use of coupling features 863.

In some cases, the body 851 (including part of the body 851 of one or both portions 855) of the collet 850 may include one or more compression features 853 that allow the body 851 to transition between a compressed state and a default state. For example, in this case, the part of the body 851-1 of portion 855-1 of the collet 850 has one compression feature 853-1-1 and two additional optional compression features 853-1 (optional compression feature 853-1-2 and optional compression feature 853-1-3).

In this case, all of the compression features 853-1 of the part of the body 851-1 of portion 855-1 of the collet 850 are in the form of slots that traverse the thickness of the part of the body 851-1. Each compression feature 853-1 has a length that is less than the length 859-1 of the part of the body 851-1. Also, each of the compression features 853-1 of the part of the body 851-1 may be arranged in any of a number of ways. For example, in this case, all of the compression features 853-1 of the part of the body 851-1 are arranged in parallel with each other but in a staggered configuration, where compression feature 853-1-1 and compression feature 853-1-3 originate at one end (e.g., the top end) of the part of the body 851-1, and where compression feature 853-1-2 originates at the opposite end (e.g., the bottom end) of the part of the body 851-1.

Also, in this example, the part of the body 851-2 of portion 855-2 of the collet 850 has three optional compression features 853-2 (compression feature 853-2-1, optional compression feature 853-2-2, and optional compression feature 853-2-3). In this case, all of the compression features 853-2 of the part of the body 851-2 of portion 855-2 of the collet 850 are in the form of slots that traverse the thickness of the part of the body 851-2. Each compression feature 853-2 has a length that is less than the length 859-2 of the part of the body 851-2. Also, each of the compression features 853-2 of the part of the body 851-2 may be arranged in any of a number of ways. For example, in this case, all of the compression features 853-2 of the part of the body 851-2 are arranged in parallel with each other but in a staggered configuration, where compression feature 853-2-1 and compression feature 853-2-3 originate at one end (e.g., the top end) of the part of the body 851-2, and where compression feature 853-2-2 originates at the opposite end (e.g., the bottom end) of the part of the body 851-2.

When the body 851 of the collet 850 (or parts of the body 851 thereof) have multiple compression features 853, the configuration (e.g., shape, size, orientation) of one compression feature 853 may be the same as, or different than, the configuration of one or more of the other compression features 853. Further, if the body 851 of the collet 850 (or parts of the body 851 thereof) have a single compression feature 853, the configuration of that compression feature 853 may be different than what is shown in FIG. 8. For example, the compression feature 853 may have a spiral shape or an “X” shape. The configuration (e.g., width and length of each compression feature 853) may be engineered in such a way as to predict the extent that the width 858 of the body 851 (and so also the width of the collective core 854) is reduced and/or deformed.

In some cases, the collet 850 may include one or more optional coupling features 853 (e.g., coupling feature 853-1, coupling feature 853-2) that allow portion 855-1 and portion 855-2 of the collet 850 to be coupled to each other. Such coupling features 853 may be designed to complement each other. The coupling features 853 may take any of a number of forms, including but not limited to complementary mating threads, a tab and a slot, a tab and a protrusion, and a protrusion and a recess. Each coupling feature 853 may be located on any part of a portion 855 of the collet 850 in order to function properly in light of its form.

With respect to FIG. 9, the X portions 955 (portion 955-1 through portion 955-X) of the collet 950 are shown as individual pieces that are separated from each other. When the portions 955 are separated from each other, each portion 955 has part, but not the whole, of the various characteristics of the entire collet 950. For example, portion 955-1 of the collet 950 of FIG. 9 includes a part of the body 951-1, a part of the bore 954-1 that traverses through the part of the body 951-1, and a part of the channel 952-1. As another example, portion 955-X of the collet 950 of FIG. 9 includes a part of the body 951-X, a part of the bore 954-X that traverses through the part of the body 951-X, and a part of the channel 952-X.

When the two portions 955 are coupled to each other to form a single piece, the various parts of each component of the collet 950 form the whole of the components. For example, the part of the bore 954-1 of portion 955-1 through the part of the bore 954-X of portion 955-X form the entire (collective) bore 954 when portion 955-1 through portion 955-X are coupled to each other. As another example, the part of the body 951-1 of portion 955-1 through the part of the body 951-X of portion 955-X form the entire (collective) body 951 when portion 955-1 through portion 955-X are coupled to each other.

In view of the above, portion 955-1 through portion 955-X are configured to complement each other. The location, configuration, size, and/or other characteristics of the part of the body 951 (e.g., part of the body 951-1, part of the body 951-X) of a portion 955 of the collet 950 may be based on one or more of a number of factors, including but not limited to the number of portions 955, the relative shape of adjacent portions 955, the relative size of adjacent portions 955 (e.g., the width 958-1 of portion 955-1, the width 958-X of portion 955-X), and the shape and/or size of the receiving chamber (e.g., receiving chamber 336).

In some cases, portion 955-1 and portion 955-2 are coupled to each other to form the collet 950. In such cases, portion 955-1 may include one or more coupling features 963-1, and portion 955-2 may include one or more coupling features 963-2 that complement the coupling features 963-1 of portion 955-1. Alternatively, portion 955-1 and portion 955-2 may be pieced together by abutting adjacent surfaces to form the collet 950 without the use of coupling features 963.

In some cases, the body 951 (including part of the body 951 of one or more portions 955) of the collet 950 may include one or more compression features 953 that allow the body 951 to transition between a compressed state and a default state. For example, in this case, the part of the body 951-1 of portion 955-1 of the collet 950 has one compression feature 953-1-1 and two additional optional compression features 953-1 (optional compression feature 953-1-2 and optional compression feature 953-1-3).

In this case, all of the compression features 953-1 of the part of the body 951-1 of portion 955-1 of the collet 950 are in the form of slots that traverse the thickness of the part of the body 951-1. Each compression feature 953-1 has a length that is less than the length 959-1 of the part of the body 951-1. Also, each of the compression features 953-1 of the part of the body 951-1 may be arranged in any of a number of ways. For example, in this case, all of the compression features 953-1 of the part of the body 951-1 are arranged in parallel with each other but in a staggered configuration, where compression feature 953-1-1 and compression feature 953-1-3 originate at one end (e.g., the top end) of the part of the body 951-1, and where compression feature 953-1-2 originates at the opposite end (e.g., the bottom end) of the part of the body 951-1.

Also, in this example, the part of the body 951-X of portion 955-X of the collet 950 has three optional compression features 953-X (compression feature 953-X-1, optional compression feature 953-X-2, and optional compression feature 953-X-3). In this case, all of the compression features 953-X of the part of the body 951-X of portion 955-X of the collet 950 are in the form of slots that traverse the thickness of the part of the body 951-X. Each compression feature 953-X has a length that is less than the length 959-X of the part of the body 951-X. Also, each of the compression features 953-X of the part of the body 951-X may be arranged in any of a number of ways. For example, in this case, all of the compression features 953-X of the part of the body 951-X are arranged in parallel with each other but in a staggered configuration, where compression feature 953-X-1 and compression feature 953-X-3 originate at one end (e.g., the top end) of the part of the body 951-X, and where compression feature 953-X-2 originates at the opposite end (e.g., the bottom end) of the part of the body 951-X.

When the body 951 of the collet 950 (or parts of the body 951 thereof) have multiple compression features 953, the configuration (e.g., shape, size, orientation) of one compression feature 953 may be the same as, or different than, the configuration of one or more of the other compression features 953. Further, if the body 951 of the collet 950 (or parts of the body 951 thereof) have a single compression feature 953, the configuration of that compression feature 953 may be different than what is shown in FIG. 9. For example, the compression feature 953 may have a spiral shape or an “X” shape. The configuration (e.g., width and length of each compression feature 953) may be engineered in such a way as to predict the extent that the width 958 of the body 951 (and so also the width of the collective core 954) is reduced and/or deformed.

In some cases, the collet 950 may include one or more optional coupling features 953 (e.g., coupling feature 953-1, coupling feature 953-X) that allow portion 955-1 through portion 955-X of the collet 950 to be coupled to each other. Such coupling features 953 may be designed to complement each other. The coupling features 953 may take any of a number of forms, including but not limited to complementary mating threads, a tab and a slot, a tab and a protrusion, and a protrusion and a recess. Each coupling feature 953 may be located on any part of a portion 955 of the collet 950 in order to function properly in light of its form.

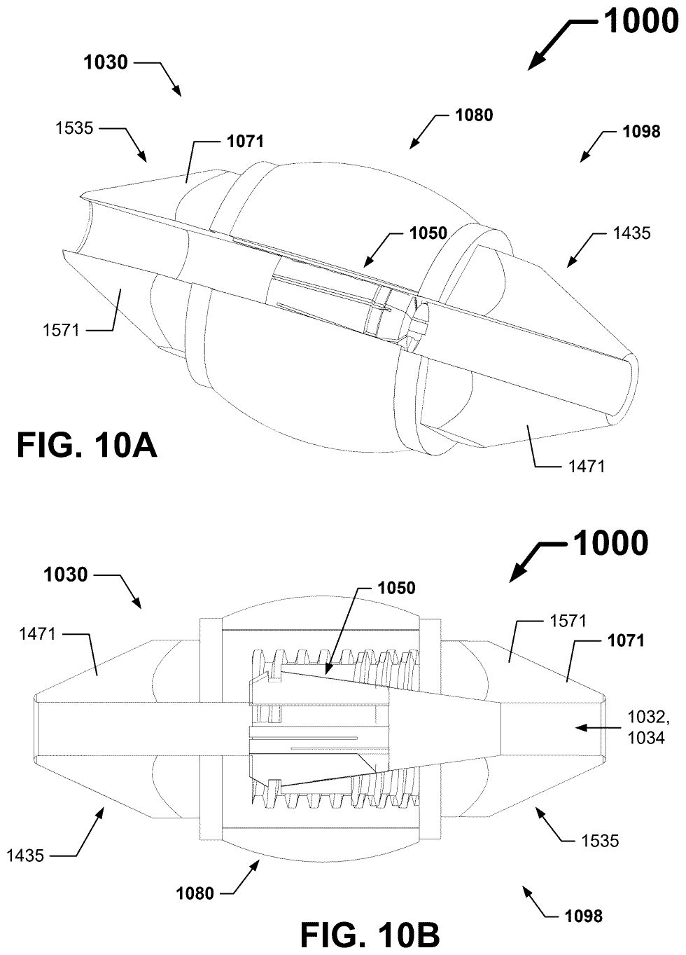

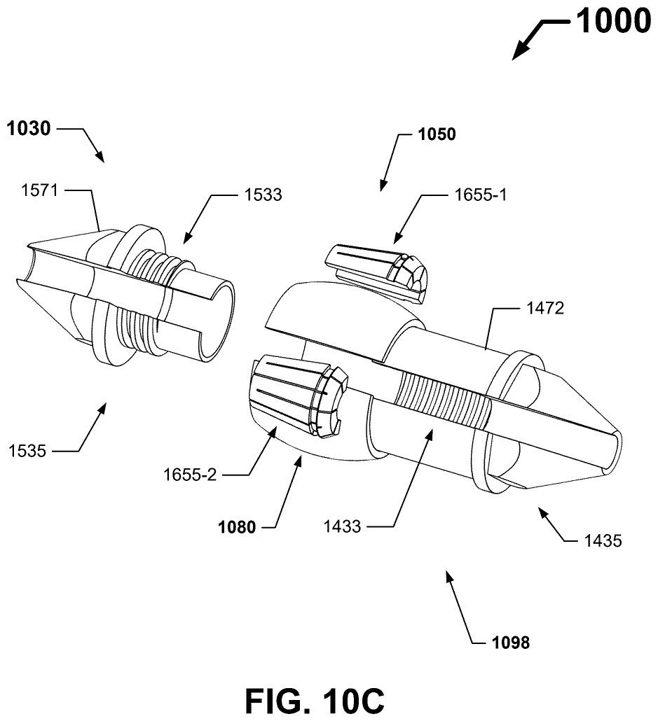

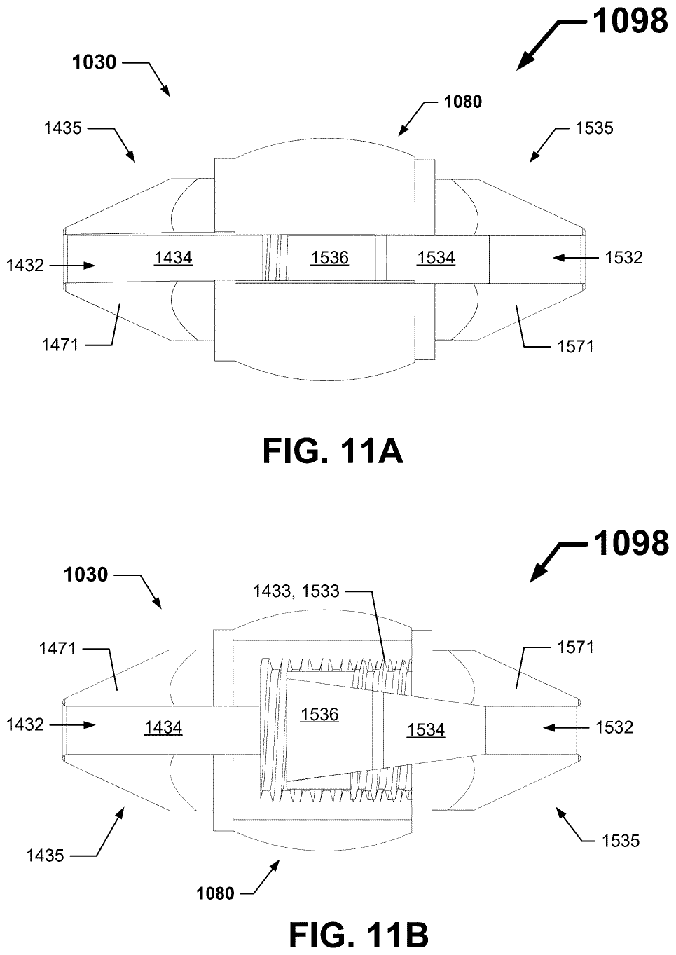

FIGS. 10A through 10C show various views of cable protection apparatus 1000 according to certain example embodiments. Specifically, FIG. 10A shows a side perspective view of the cable protection apparatus 1000. FIG. 10B shows a sectional side view of the cable protection apparatus 1000. FIG. 10C shows an exploded view of the cable protection apparatus 1000. FIGS. 11A and 11B show various views of a subset 1098 of the cable protection apparatus 1000 of FIGS. 10A through 10C according to certain example embodiments. Specifically, FIG. 11A shows a side view of the subset 1098, and FIG. 11B shows a sectional side view of the subset 1098, where the subset 1098 includes the enclosure 1030 and the sleeve 1080 without the collet 1050.

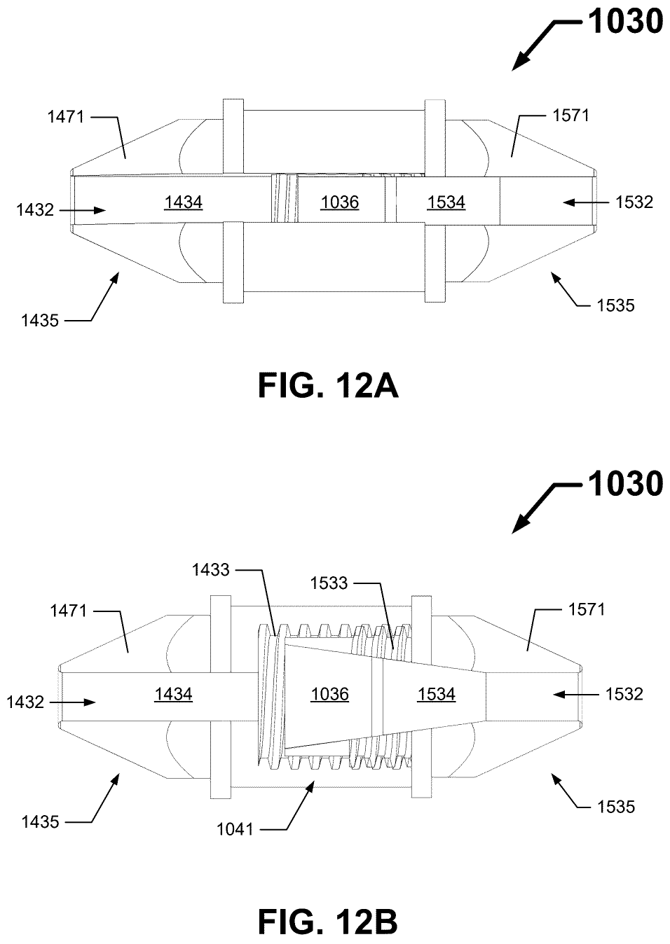

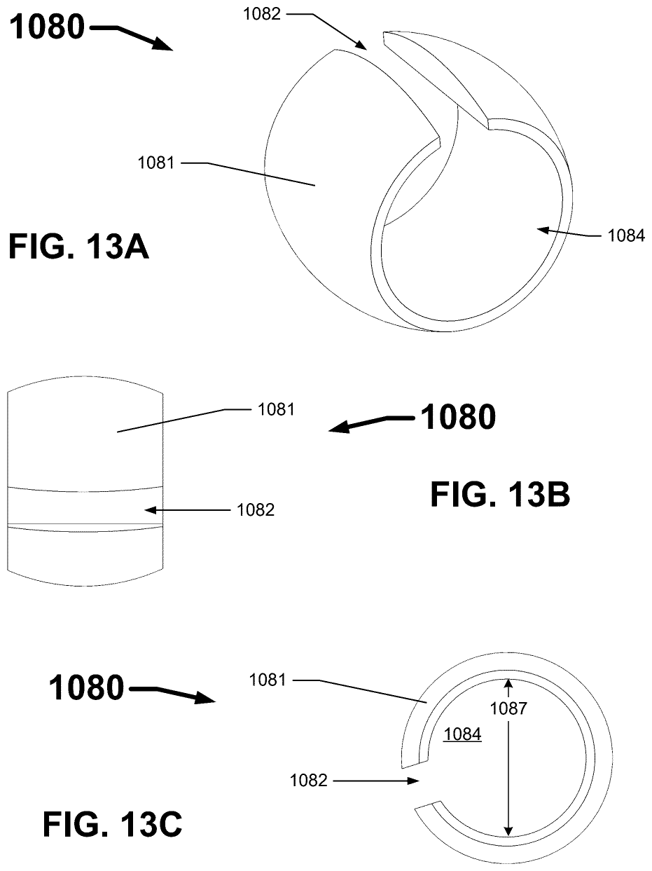

FIGS. 12A and 12B show various views of the enclosure 1030 of the cable protection apparatus 1000 of FIGS. 10A through 10C and the subset 1098 of FIGS. 11A and 11B according to certain example embodiments. Specifically, FIG. 12A shows a side view of the enclosure 1030, and FIG. 12B shows a sectional side view of the enclosure 1030. FIGS. 13A through 13C show various views of the sleeve 1080 of the cable protection apparatus 1000 of FIGS. 10A through 10C and the subset 1098 of FIGS. 11A and 11B according to certain example embodiments. Specifically, FIG. 13A shows a perspective view of the sleeve 1080. FIG. 13B shows a side view of the sleeve 1080. FIG. 13C shows a top view of the sleeve 1080.

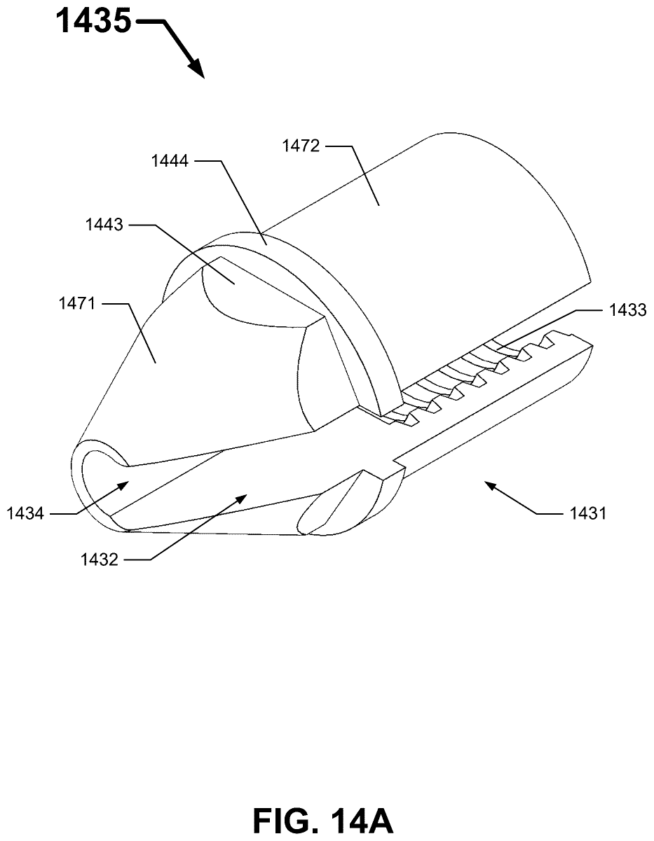

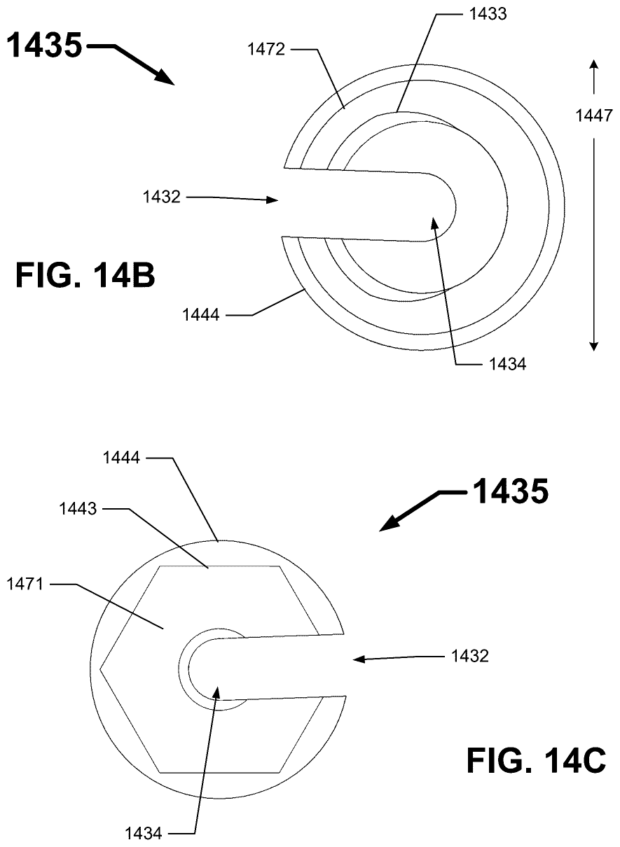

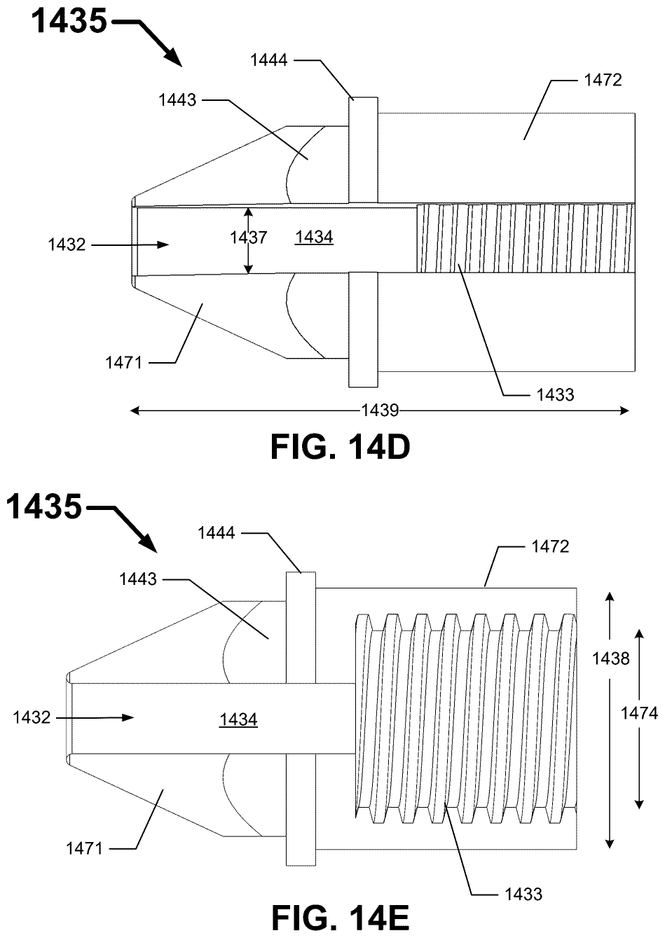

FIGS. 14A through 14E show various views of one portion 1435 of the enclosure 1030 of FIGS. 12A and 12B according to certain example embodiments. Specifically, FIG. 14A shows a perspective view of the portion 1435 of the enclosure 1030. FIG. 14B shows a rear view of the portion 1435 of the enclosure 1030. FIG. 14C shows a front view of the portion 1435 of the enclosure 1030. FIG. 14D shows a side view of the portion 1435 of the enclosure 1030. FIG. 14E shows a sectional side view of the portion 1435 of the enclosure 1030.

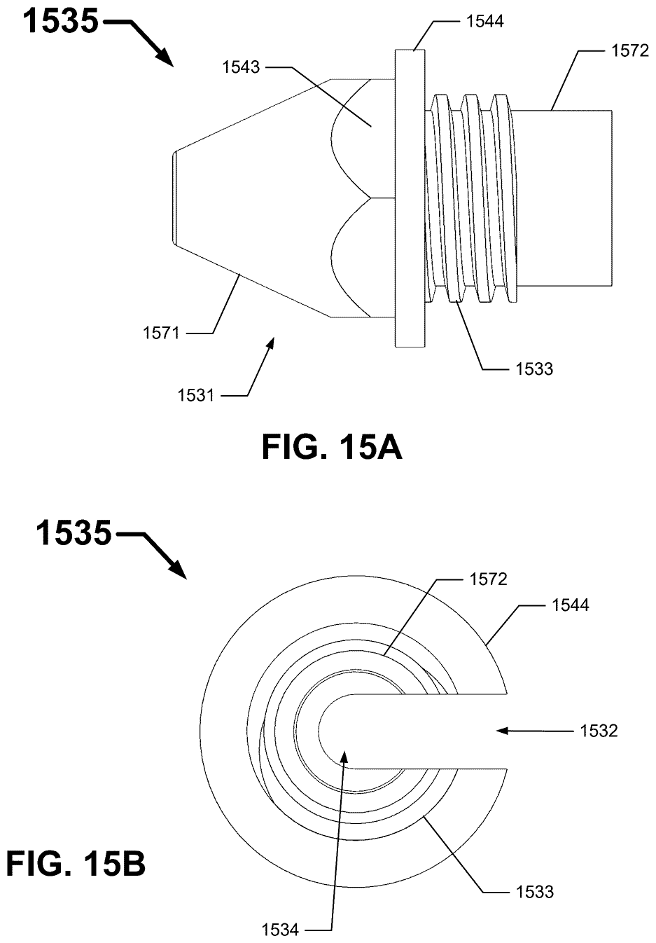

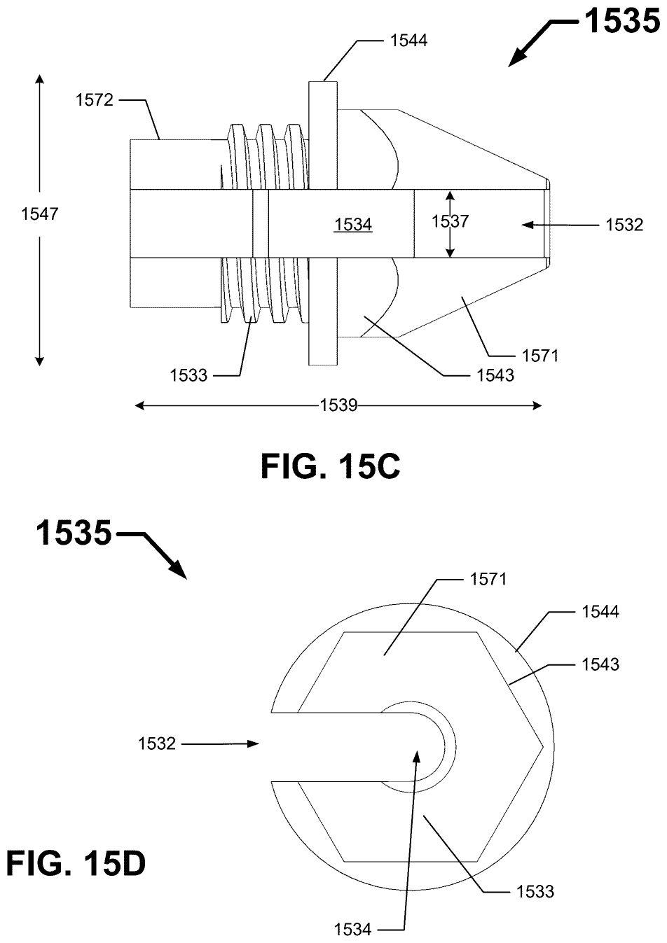

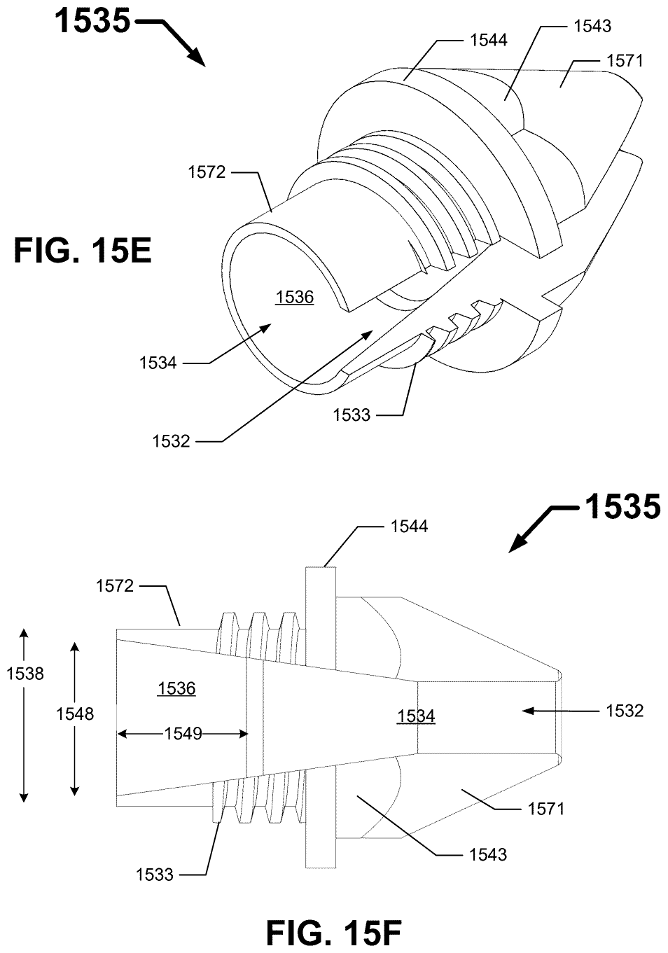

FIGS. 15A through 15F show various views of another portion 1535 of the enclosure 1030 of FIGS. 12A and 12B according to certain example embodiments. Specifically, FIG. 15A shows a side view of the portion 1535 of the enclosure 1030. FIG. 15B shows a rear view of the portion 1535 of the enclosure 1030. FIG. 15C shows another side view of the portion 1535 of the enclosure 1030. FIG. 15D shows a front view of the portion 1535 of the enclosure 1030. FIG. 15E shows a perspective view of the portion 1535 of the enclosure 1030. FIG. 15F shows a sectional side view of the portion 1535 of the enclosure 1030.

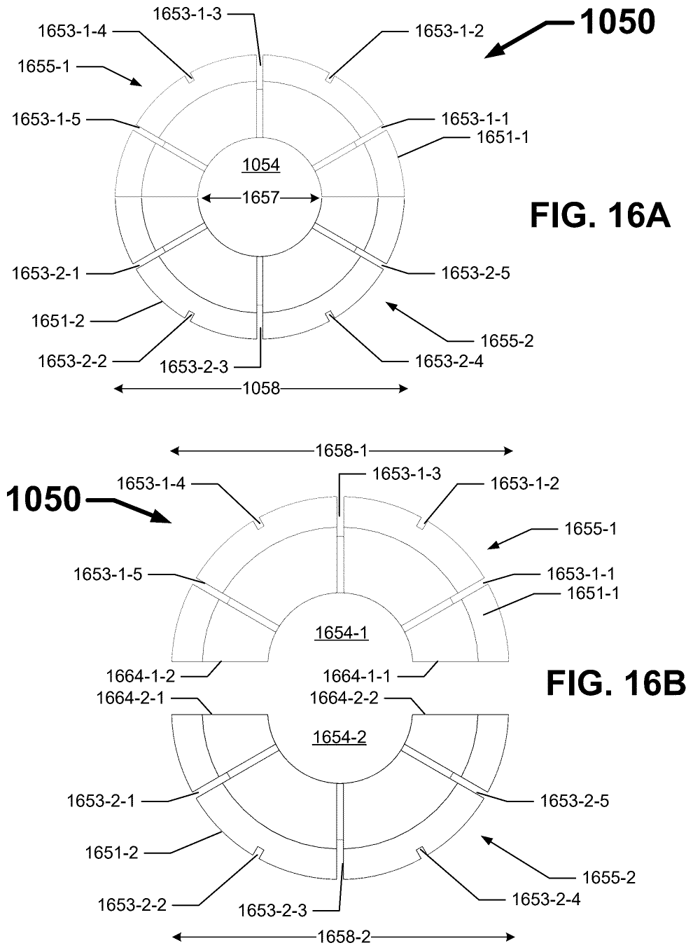

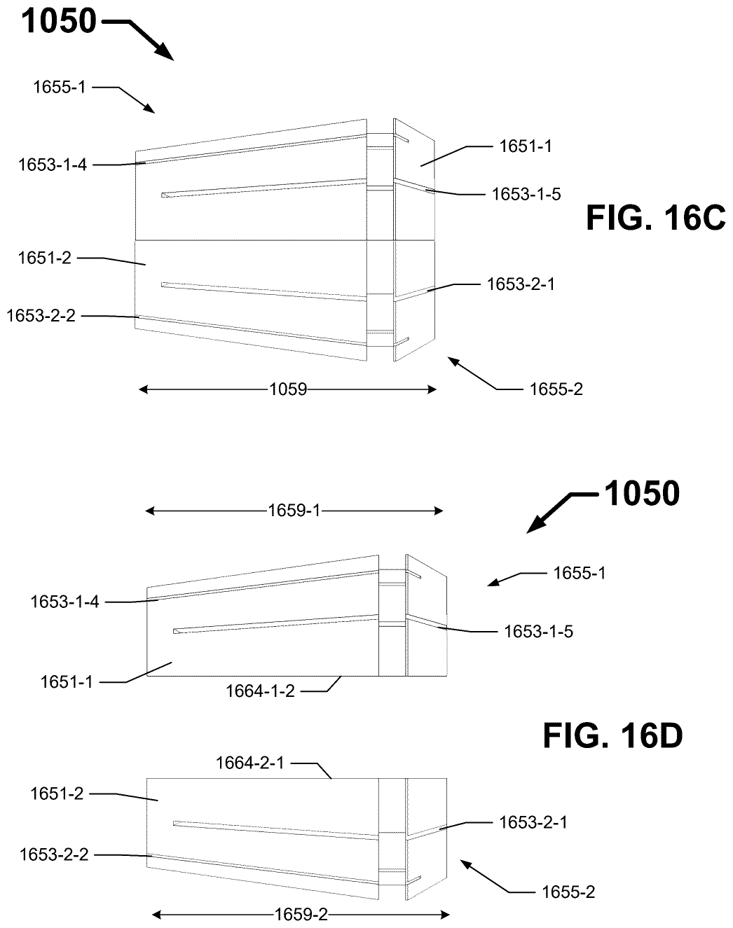

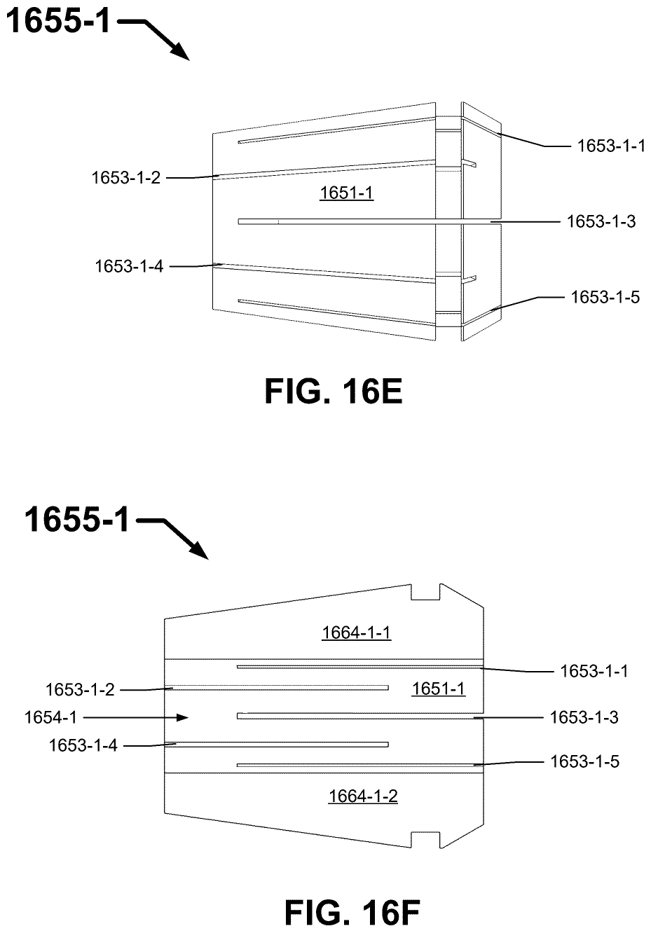

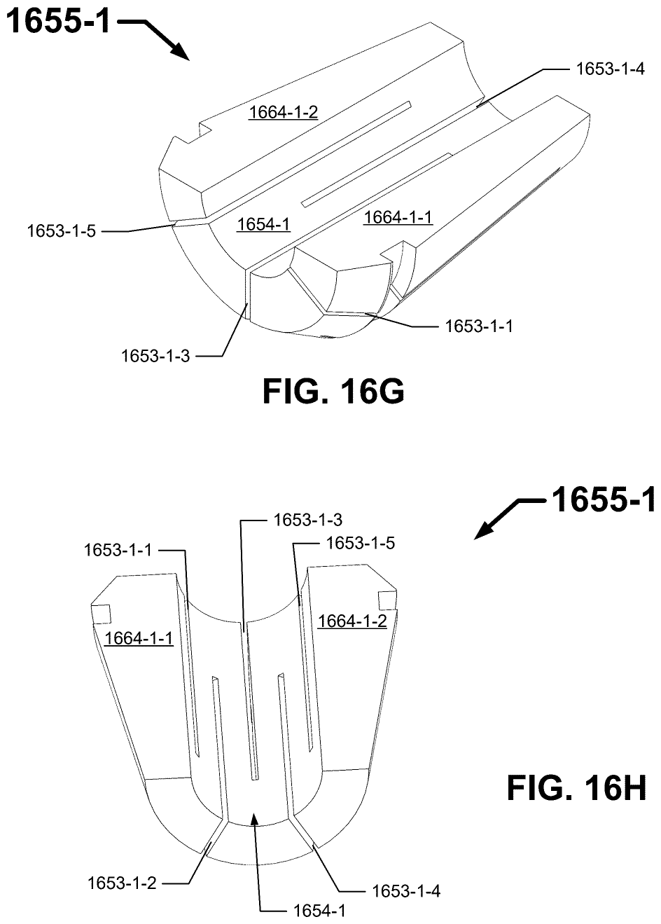

FIGS. 16A through 16H show various views of the collet 1050 of the cable protection apparatus 1000 of FIGS. 10A through 10C according to certain example embodiments. Specifically, FIG. 16A shows a front view of the collet 1050. FIG. 16B shows an exploded front view of the collet 1050. FIG. 16C shows a side view of the collet 1050. FIG. 16D shows an exploded side view of the collet 1050. FIG. 16E shows a side view of a portion 1655-1 of the collet 1050. FIG. 16F shows another side view of the portion 1655-1 of the collet 1050. FIGS. 16G and 16H show perspective views of the portion 1655-1 of the collet 1050.

Referring to the description above with respect to FIGS. 1 through 9, the cable protection apparatus 1000 includes the enclosure 1030, the collet 1050, and the sleeve 1080, where the enclosure 1030 includes portion 1435 and portion 1535. The collet 1050 in this case is made up of two portions 1655 (portion 1655-1 and portion 1655-2). In this way, the collet 1050 is similar to the multi-portion collets discussed above with respect to FIGS. 8 and 9. For example, the two portions 1655 (portion 1655-1 and portion 1655-2) of the collet 1050 are shown as individual pieces that are substantially identical to each other.

When the portions 1655 are separated from each other, each portion 1655 has part, but not the whole, of the various characteristics of the entire collet 1050. For example, portion 1655-1 of the collet 1050 of FIGS. 16A through 16H includes a part of the body 1651-1 and a part of the bore 1654-1 that traverses through the part of the body 1651-1. Because of the particular configuration of the collet 1050 in this case, specifically that each portion 1655 is placed over a cable (e.g., cable 115, cable 215) until the both portions 1655 abut against each other to form the entire collet 1050, there is no channel (e.g., channel 852). Similarly, portion 1655-2 of the collet 1050 of FIGS. 16A through 16H includes a part of the body 1651-2 and a part of the bore 1654-2 that traverses through the part of the body 1651-2.

In this case, neither of the portions 1655 of the collet 1050 has any coupling features (e.g., coupling features 863, coupling features 963). Instead, mating surfaces 1664 abut against each other. Specifically, portion 1655-1 has mating surface 1664-1-1 and mating surface 1664-1-2, and portion 1655-1 has mating surface 1664-2-1 and mating surface 1664-2-2. When the collet 1050 is made whole, mating surface 1664-1-1 of portion 1655-1 abuts against mating surface 1664-2-2 of portion 1655-2, and mating surface 1664-1-2 of portion 1655-1 abuts against mating surface 1664-2-1 of portion 1655-2.

In this case, all of the mating surfaces 1664 are featureless. In alternative embodiments, one or more of the mating surfaces 1664 includes one or more features (e.g., detents, tabs, slots, protrusions, recesses) that help secure abutting mating surfaces 1664 to each other. When both mating surfaces 1664 that abut against each other include such features, then those features may complement each other to help ensure that the abutting mating surfaces 1664 are secure.

When the two portions 1655 are joined to form a single piece, the various parts of each component of the collet 1050 form the whole of the components. For example, the part of the bore 1654-1 of portion 1655-1 and the part of the bore 1654-2 of portion 1655-2 form the entire bore 1654 when portion 1655-1 and portion 1655-2 abut against each other. As another example, the part of the body 1651-1 of portion 1655-1 and the part of the body 1651-2 of portion 1655-2 form the entire body 1651 when portion 1655-1 and portion 1655-2 abut against each other. The mating surfaces 1664-1 of portion 1655-1 are oriented along the length 1659-1 of the portion 1655-1. Similarly, the mating surfaces 1664-2 of portion 1655-2 are oriented along the length 1659-2 of the portion 1655-2. As a result, when portion 1655-1 and portion 1655-2 abut against each other to form the collet 1050, the collet 1050 has a length 1059 that is the substantially the same as the lengths 1659.

The body 1651-1 of portion 1655-1 of the collet 1050 is semi-cylindrically shaped. The body 1651-1 of portion 1655-1 includes five compression features 1653-1 (substantially the same as the compression features 853 discussed above) that allow the body 1651-1 (and so also the collective body 1651) to transition between a compressed state and a default state. Specifically, when a sufficiently strong inward force (e.g., exceeding a threshold value at which the compression features 1653 are designed to withstand without deforming) is applied to the portion 1655-1 forming the collet 1050, the size of the compression features 1653-1 are reduced along their length.

When this occurs, the width 1658-1 of the portion 1655-1 (and so also the collective width 1058 of the collet 1050) is reduced (e.g., from 2 inches to 1.5 inches, from 1 inch to 0.5 inches, from 1 inch to 0.75 inches), which results in a reduction in the width 1657 (e.g., from 2 inches to 1.5 inches, from 1 inch to 0.5 inches, from 1 inch to 0.75 inches) of the bore 1654-1 of the portion 1655-1 (and so also the width 1657 (e.g., from 2 inches to 1.5 inches, from 1 inch to 0.5 inches, from 1 inch to 0.75 inches) of the collective bore 1054 of the collet 1050). Consequently, when a cable (e.g., cable 115, cable 215) having a certain range of diameters (e.g., 0.486 inches to 0.567 inches, 0.75 inches to 1 inch, 1.5 inches to 2 inches) is disposed in the collective bore 1054 of the collet 1050, the inner surfaces of the body 1651-1 of the portion 1655-1 applies a compressive force to the cable.

In this case, the body 1651-1 of portion 1655-1 has three compression features 1653-1 (compression feature 1653-1-1, compression feature 1653-1-3, and compression feature 1653-1-5) that begin at the wide (e.g., proximal) end of the body 1651-1 of portion 1655-1 and terminate toward (but short of) the narrow (e.g., distal) end of the body 1651-1. The other two compression features 1653-1 (compression feature 1653 -1-2 and compression feature 1653-1-4) begin at the narrow end of the body 1651-1 of portion 1655-1 and terminate toward (but short of) the wide end of the body 1651-1.

In this case, all of the compression features 1653-1 of the body 1651-1 of portion 1655-1 of the collet 1050 are in the form of slots that traverse the thickness of the body 1651-1. Each compression feature 1653-1 has a length that is less than the length 1659-1 of the body 1651-1. Also, all of the compression features 1653-1 of the part of the body 1651-1 are arranged in parallel and are spaced equidistantly from each other. Further, the various characteristics (e.g., length, width) of all of the compression features 1653-1 in this case are substantially the same as each other.

Similarly, the body 1651-2 of portion 1655-2 of the collet 1050 is also semi-cylindrically shaped. The body 1651-2 of portion 1655-2 includes five compression features 1653-2 (substantially the same as the compression features 853 discussed above) that allow the body 1651-2 (and so also the collective body 1651) to transition between a compressed state and a default state. Specifically, when a sufficiently strong inward force (e.g., exceeding a threshold value at which the compression features 1653 are designed to withstand without deforming) is applied to the portion 1655-2 forming the collet 1050, the size of the compression features 1653-2 are reduced along their length. When this occurs, the width 1658-2 of the portion 1655-2 (and so also the collective width 1058 of the collet 1050) is reduced, which results in a reduction in the width 1657 of the bore 1654-2 of the portion 1655-2 (and so also the width 1657 of the collective bore 1054 of the collet 1050). Consequently, when a cable (e.g., cable 115, cable 215) is disposed in the collective bore 1054 of the collet 1050, the inner surfaces of the body 1651-2 of the portion 1655-2 applies a compressive force to the cable.

In this case, the body 1651-2 of portion 1655-2 has three compression features 1653-2 (compression feature 1653-2-1, compression feature 1653-2-3, and compression feature 1653-2-5) that begin at the wide (e.g., proximal) end of the body 1651-2 of portion 1655-2 and terminate toward (but short of) the narrow (e.g., distal) end of the body 1651-2. The other two compression features 1653-2 (compression feature 1653-2-2 and compression feature 1653-2-4) begin at the narrow end of the body 1651-2 of portion 1655-2 and terminate toward (but short of) the wide end of the body 1651-2.

In this case, all of the compression features 1653-2 of the body 1651-2 of portion 1655-2 of the collet 1050 are in the form of slots that traverse the thickness of the body 1651-2. Each compression feature 1653-2 has a length that is less than the length 1659-2 of the body 1651-2. Also, all of the compression features 1653-2 of the part of the body 1651-2 are arranged in parallel and are spaced equidistantly from each other. Further, the various characteristics (e.g., length, width) of all of the compression features 1653-2 in this case are substantially the same as each other.

The portion 1435 and the portion 1535 of the enclosure 1030 are shown as individual pieces that are detachably coupled to each other. When portion 1435 and portion 1535 of the body 1041 are separated from each other, each of portion 1435 and portion 1535 has part, but not the whole, of the various characteristics of the entire enclosure 1030. When portion 1435 and portion 1535 are coupled to each other to form the enclosure 1030 in a single piece, the various parts of each component of the enclosure 1030 form the whole of the components (e.g., the collective bore 1034, the collective channel 1032, the collective body 1031).

The portion 1435 of the enclosure 1030 includes a body 1431, a bore 1434 that traverses the body 1431 along its length 1439, a channel 1432, and an adjustment feature 1433. These features of the portion 1435 of the enclosure 1030 are substantially the same as the corresponding features of the enclosures discussed above. The body 1431 in this case includes an distal end 1471, a collar 1472, and a transition protrusion 1444 located between the distal end 1471 and the collar 1472. The bore 1434 and the channel 1432 have a height 1437 (e.g., 0.5 inches, 1 inch, 2 inches, 3 inches) that are substantially equal to each other. The height 1437 is at least as large as the outer diameter of a cable (e.g., cable 115, cable 215) that is being protected by the cable protection apparatus 1000.

The distal end 1471 of the body 1431 of the portion 1435 is located at the distal end of the body 1431 and is conically shaped in this example. In some cases, the distal end 1471 (or at least the outer surface thereof) includes or is made of a material that is wear resistant. In certain example embodiments, as in this case, distal end 1471 of the body 1431 includes a tightening feature 1443 disposed on its outer surface. In this example, the tightening feature 1443 abuts against the transition protrusion 1444. The tightening feature 1443 may be configured to be engaged by a tool (e.g., a wrench, a set of pliers) to secure the enclosure 1030 in the engaged position by tightening the distal end 1571 and the distal end 1471 relative to each other.

The transition protrusion 1444 of the body 1431 has a height 1447 that exceeds the maximum height of the distal end 1471 and the height 1438 of the collar 1472. In some cases, the transition protrusion 1444 may serve as a boundary or stop for the sleeve 1080, discussed below. The collar 1472 of the body 1431 is substantially cylindrical in shape in this case. The collar 1472 of the body 1431 has a height 1438 (in this case, a diameter) that is less than the height 1447 (in this case, a diameter) of the transition protrusion 1444. Also, the inner surface of the collar 1472 has a height 1474 (in this case, a diameter) that is at least as large as the collective width 1058 of the collet 1050 when the enclosure 1030 is in the disengaged position.

Along the inner surface of the collar 1472 is an adjustment feature 1433 in the form of mating threads. In this case, the adjustment feature 1433 is used to couple the portion 1435 and the portion 1535 relative to each other to form the enclosure 1030 (thereby manipulating the body 1031 of the enclosure 1030 between the engaged position and the disengaged position), as well as to control the size of the receiving chamber 1536, part of which is bounded by the collar 1472 along its inner surface. The adjustment feature 1433 of the portion 1435 is configured to complement the adjustment feature 1533 of the portion 1535, discussed below. For example, in alternative embodiments, the collar 1472 may have a smaller height, and the adjustment feature 1433 (e.g., in the form of mating threads) may be disposed on the outer surface of the collar 1472.

The portion 1535 of the enclosure 1030 includes a body 1531, a bore 1534 that traverses the body 1531 along its length 1539, a channel 1532, and an adjustment feature 1533. These features of the portion 1535 of the enclosure 1030 are substantially the same as the corresponding features of the enclosures discussed above. The body 1531 in this case includes a distal end 1571, a collar 1572, and a transition protrusion 1544 located between the distal end 1571 and the collar 1572. The bore 1534 and the channel 1532 have a height 1537 that are substantially equal to each other. The height 1537 is at least as large as the outer diameter of a cable (e.g., cable 115, cable 215) that is being protected by the cable protection apparatus 1000.

The distal end 1571 of the body 1531 of the portion 1535 is located at the distal end of the body 1531 and is conically shaped in this example. In some cases, the distal end 1571 (or at least the outer surface thereof) includes or is made of a material that is wear resistant. In certain example embodiments, as in this case, the distal end 1571 of the body 1531 includes a tightening feature 1543 disposed on its outer surface. In this example, the tightening feature 1543 abuts against the transition protrusion 1544. The tightening feature 1543 may be configured to be engaged by a tool (e.g., a wrench, a set of pliers) to secure the enclosure 1030 in the engaged position by tightening the distal end 1471 and the distal end 1571 relative to each other.

The transition protrusion 1544 of the body 1531 has a height 1547 that exceeds the maximum height of the distal end 1571 and the height 1538 of the collar 1572. In some cases, the transition protrusion 1544 may serve as a boundary or stop for the sleeve 1080, discussed below. The collar 1572 of the body 1531 is substantially cylindrical in shape in this case. The collar 1572 of the body 1531 has a height 1538 (in this case, a diameter) that is less than the height 1547 (in this case, a diameter) of the transition protrusion 1544. Also, in this case, the inner surface of the collar 1572 has a conical shape toward its distal end, which is designed to mirror the shape of the collet 1050. In other words, the distal end of the collar 1572 along its inner surface serves as most of the receiving chamber 1536 for the collet 1050.

The inner surface of the collar 1572 has a maximum height 1548 (in this case, a diameter) at its distal end where the distal end of the receiving chamber 1536 is located. The maximum height 1548 is at least as large as the collective width 1058 of the collet 1050 when the enclosure 1030 is in the disengaged position and when the collet 1050 is in the default state. Similarly, the inner surface of the collar 1572 has a length 1549 originating at its distal end that is at least as large as the collective length 1059 of the collet 1050 when the enclosure 1030 is in the disengaged position and when the collet 1050 is in the default state. At the proximal end of the receiving chamber 1536, which in this case extends into the distal end 1571, receiving chamber 1536 transitions into the bore 1534 having the height 1537 (e.g., 0.5 inches, 1 inch, 2 inches, 3 inches). In this example, the size (e.g., the length) of the receiving chamber 1536 when the enclosure 1030 is in the disengaged position is greater than the corresponding size (e.g., the length 1059) of the collet 1050.

Along the outer surface of the collar 1572 is an adjustment feature 1533 in the form of mating threads. As discussed above with respect to the adjustment feature 1433 of the portion 1435, the adjustment feature 1533 is used to couple the portion 1535 and the portion 1535 relative to each other to form the enclosure 1030 (thereby manipulating the body 1031 of the enclosure 1030 between the engaged position and the disengaged position), as well as to control the size of the receiving chamber 1536, most of which is bounded by the inner surface of the collar 1572. The adjustment feature 1533 of the portion 1535 is configured to complement the adjustment feature 1433 of the portion 1435, as discussed above. As another example, in alternative embodiments, the collar 1572 may have a larger height, and the adjustment feature 1533 (e.g., in the form of mating threads) may be disposed on the inner surface of the collar 1572.

As discussed above, when portion 1435 and portion 1535 are coupled to each other to form a single piece, the various parts of each component of the enclosure 1030 form the whole of the components. However, since portion 1435 and portion 1535 rotate with respect to each other about an axis along their length, there are times that a component of the enclosure 1030 may lose continuity when portion 1435 and portion 1535 are coupled to each other. For example, the channel 1432 of portion 1435 and the channel 1532 of portion 1535 will be misaligned except for a small range (e.g., within 20°, within 30° for every 360° rotation.

In this example, when the collet 1050 is placed within the receiving chamber 1536, and then when the enclosure 1030 is manipulated toward and eventually into the engaged position, the body 1651 of the collet 1050 is radially compressible along the length 1659 of the collet 1050. In such cases, the collective body 1651 of the collet 1050 may have a compressed state (as shown in FIG. 5) and a default state (as shown in FIGS. 3 and 4). When the collet 1050 is in the default state, the collective bore 1654 of the collet 1050 has the width 1657 (e.g., 0.5 inches, 1 inch, 2 inches, 3 inches), and the collective body 1651 of the collet 1050 has the width 1658 (e.g., 0.5 inches, 1 inch, 2 inches, 3 inches). By contrast, when the collet 1050 is in the compressed state, the collective body 1651 of the collet 1050 has a height (e.g., 0.25 inches, 0.4 inches, 0.75 inches, 1.25 inches, 2 inches) that is less than (reduced relative to) the width 1658.

Also, when the collet 1050 is in the compressed state, the collective bore 1654 of the collet 1050 has a height that is less than (reduced relative to) the collective width 1657 (also sometimes called the default collective width 1657). When the collet 1050 is in the compressed state, the cross-sectional shape of the collective bore 1654 may be the same as, or different than, the cross-sectional shape of the collective bore 1654 when the collet 1050 is in the default state.

The optional sleeve 1080 of the cable protection apparatus 1000 is configured to protect at least some of the enclosure 1030 when the cable protection apparatus 1000 is coupled to a cable (e.g., cable 115, cable 215) in the field (e.g., in a wellbore 120, in a building structure). Specifically, the sleeve 1080 is configured to be disposed over a portion of the enclosure 1030. In this particular case, as shown in FIGS. 10A through 11B, the sleeve 1080 is configured to be disposed over the outer surface of the collar 1472 of the portion 1435 between the transition protrusion 1444 of portion 1435 and the transition protrusion 1544 of portion 1535.

The sleeve 1080 has a body 1081 that in this case is generally tubular in shape to form a core 1084 that traverses the length of the body 1081. The shape and size of the core 1084 may be configured to match the tubular shape of the collar 1472 of the portion 1435 of the enclosure 1030. In some cases, the sleeve 180 may be configured to freely rotate about the enclosure 1030 when the sleeve 1080 is placed over the collar 1472. The sleeve 1080 also has a channel 1082 that traverses the thickness of the body 1081. The width of the channel 1082 may be at least as large as the diameter of a cable (e.g., cable 115, cable 215) that is secured by the cable protection apparatus 1000. As such, the width of the channel 1082 may be substantially the same as, or larger than, the height 1437 of the channel 1432 of the portion 1435 and/or the height 1537 of the channel 1532 of the portion 1535.

The inner surface of the body 1081 of the sleeve 1080 forms a diameter 1087 that is at least as large as the height 1438 of the outer surface of the collar 1472 of the portion 1435 of the enclosure 1030. As a result, the sleeve 1080 is movable (e.g., rotatable, slidable) relative to the enclosure 1030 when the sleeve 1080 is disposed over the collar 1472 of the portion 1435 (and/or some other portion of the enclosure 1030). In certain example embodiments, at least some portion (e.g., the outer surface) of the body 1081 of the sleeve 1080 is made of or includes a material that is wear resistant.

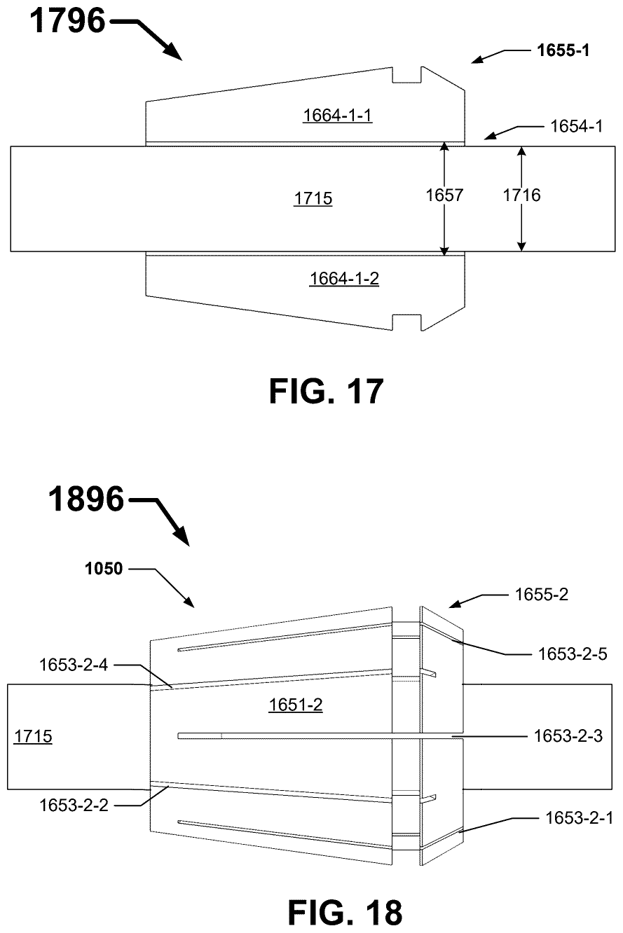

FIGS. 17 through 22 show a progression of systems showing the enclosure 1030 (including portions thereof) of FIGS. 10A through 10C becoming engaged with a cable 1715 according to certain example embodiments. Referring to the description with respect to FIGS. 1 through 16H above, the system 1796 of FIG. 17 shows part of a cable 1715 being disposed within the portion 1655-1 of the bore 1654-2. The cable 1715 has a width 1716 (also called a diameter) that is no greater than the width 1657 of the bore 1654-2. This leaves the half of the part of the cable 1715, as well as mating surface 1664-1-1 and mating surface 1664-1-2, exposed.

The system 1896 of FIG. 18 captures a point in time subsequent to the time captured in FIG. 17. The system 1896 adds the portion 1655-2 being placed over the previously exposed part of the cable 1715 atop the portion 1655-1 to form the collet 1050, which now completely encloses the part of the cable 1715. The collet 1050 in FIG. 18 is in the default state as indicated by the compression features 1653-2 (e.g., compression feature 1653-2-1, compression feature 1653-2-2, compression feature 1653-2-3, compression feature 1653-2-4, and compression feature 1653-2-5) having their original shape relative to the body 1651-2 of the portion 1655-2.

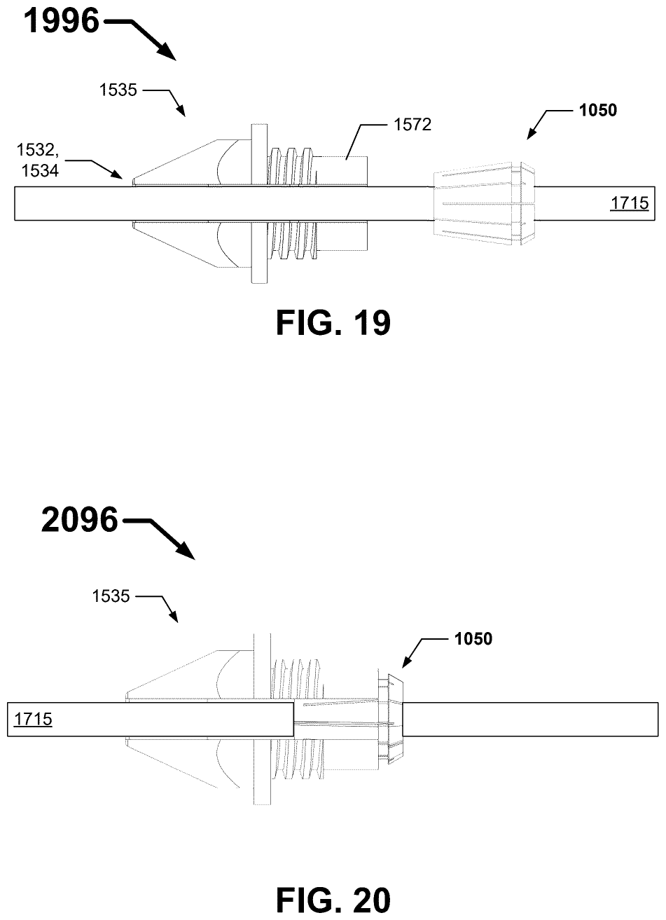

The system 1996 of FIG. 19 captures a point in time subsequent to the time captured in FIG. 18. The system 1996 adds portion 1535, where another portion of the cable 1715 is positioned in the bore 1534 of the portion 1535 after passing through the channel 1532 of the portion 1535. The collar 1572 of the portion 1535 is positioned adjacent to the collet 1050. The system 2096 of FIG. 20 captures a point in time subsequent to the time captured in FIG. 19. The system 2096 does not add any components relative to FIG. 19. Rather, most of the collet 1050 is now positioned inside collar 1572.

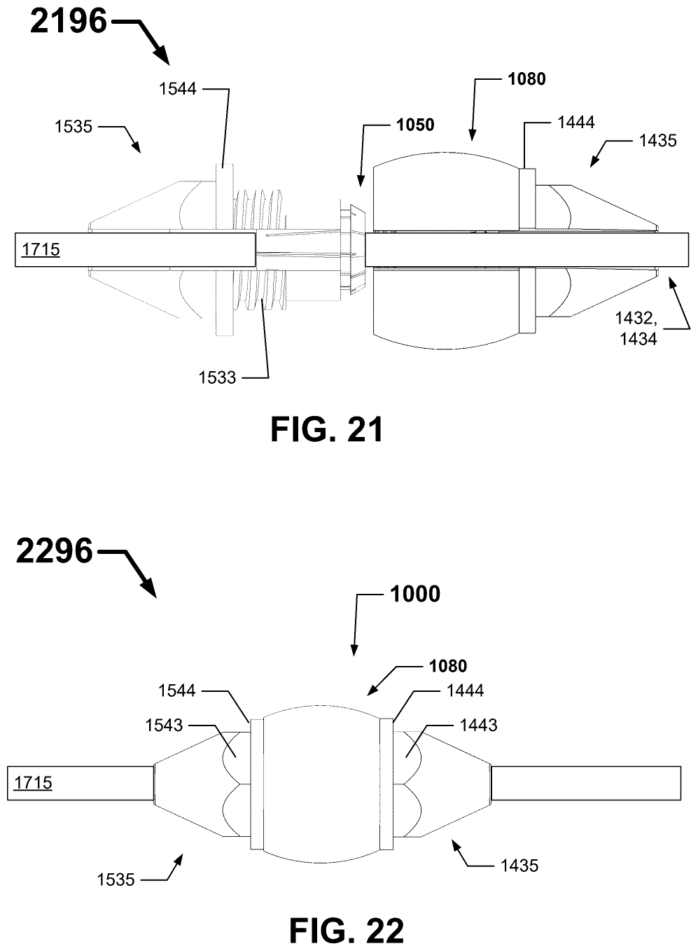

The system 2196 of FIG. 21 captures a point in time subsequent to the time captured in FIG. 20. The system 2196 adds portion 1435, where another portion of the cable 1715 is positioned in the bore 1434 of the portion 1435 after passing through the channel 1432 of the portion 1435. The collar of the portion 1435, covered by the sleeve 1080, is positioned adjacent to the collet 1050, which is still mostly positioned inside the collar 1572 of the portion 1535. The adjustment feature 1533 in the form of mating threads is disposed on the outer surface of the collar 1572 adjacent to the transition protrusion 1544 of the portion 1535. The sleeve 1080 abuts against the transition protrusion 1444 of the portion 1435.

The system 2296 of FIG. 22 captures a point in time subsequent to the time captured in FIG. 21. The system 2296 does not add any components relative to FIG. 21. Rather, the enclosure 1030 is assembled by moving portion 1535 and portion 1435 toward each other, and then rotating portion 1535 and portion 1435 relative to each other by hand (e.g., without the use of tools) and/or using a tool (e.g., a wrench) in conjunction with tightening feature 1543 of portion 1535 and/or tightening feature 1443 of portion 1435. This places the enclosure 1030 in the engaged position, which applies a compressive force to the collet 1050, where the compressive force is sufficiently large to put the collet 1050 in a compressed state by reducing the size of the compression features 1653 of the collet 1050.

When the collet 1050 is in the compressed state, the size of the bore of the collet 1050 is reduced to the point that the inner surface of the collet 1050 applies a compressive force, derived from the compressive force applied by the enclosure 1030 to the collet 1050, to the cable 1715, which prevents the cable protection apparatus 1000 from moving relative to the cable 1715, regardless of the forces (e.g., tension, friction) applied to the cable 1715 and/or the cable protection apparatus 1000 in the field. In certain example embodiments, the adjustment features (e.g., adjustment feature 1433, adjustment feature 1533) are configured (e.g., using the transition protrusion 1444, using the transition protrusion 1544, using a locking mechanism integrated with one or more of the adjustment features) to keep the enclosure body 1031 in an engaged position until the adjustment features are purposely acted upon to return the enclosure 1030 to the disengaged position. The sleeve 1080 of the cable protection apparatus 1000 may freely rotate relative to the enclosure 1030 between the transition protrusion 1444 and the transition protrusion 1544.

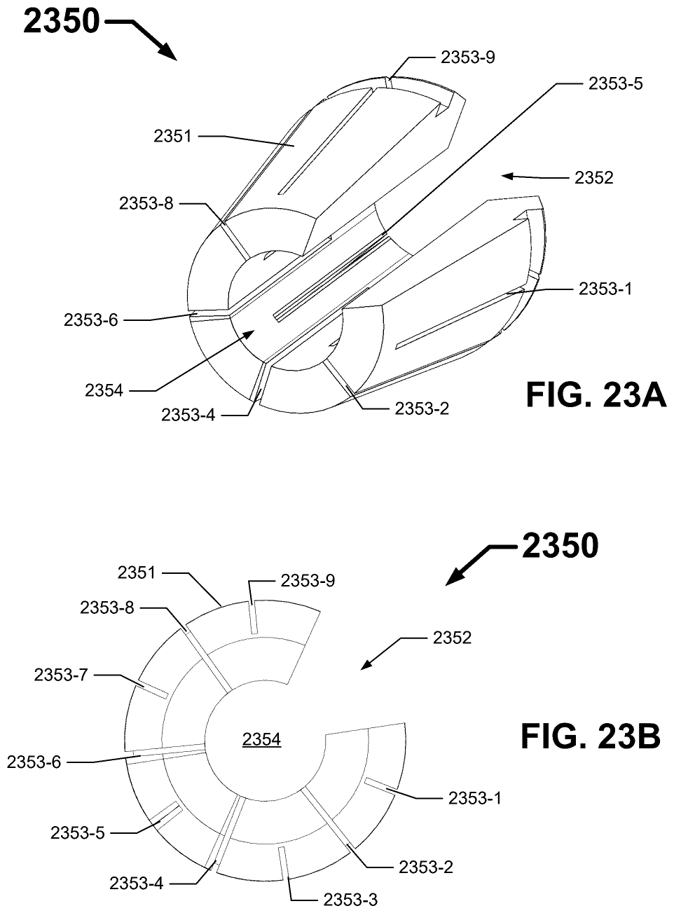

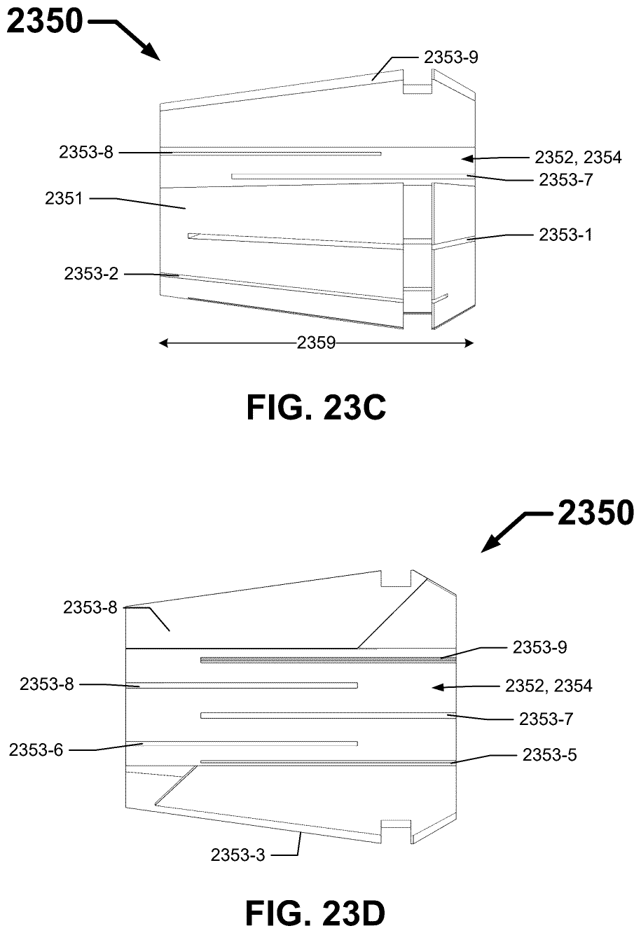

FIGS. 23A through 23D show various views of an alternative collet 2350 having a single portion that may be used with the enclosure 1030 of FIGS. 12A and 12B according to certain example embodiments. Specifically, FIG. 23A shows a perspective view of the collet 2350. FIG. 23B shows a front view of the collet 2350. FIG. 23C shows a side view of the collet 2350. FIG. 23D shows a sectional side view of the collet 2350. Referring to the description with respect to FIGS. 1 through 22 above, in this case the body 2351 of the collet 2350 is substantially the same as the collective body 1651 of the collet 1050 of FIGS. 16A through 16H above with two notable exceptions. First, the body 2351 of the collet 2350 in this case is a single piece.

Second, the collet 2350 in this case also has a channel 2352 that traverses the thickness of the body 2351 to the bore 2354 along the length 2359 of the collet 2350. The width of the channel 2352 may be at least as large as the diameter of a cable (e.g., cable 115, cable 215, cable 1715) that is secured by the example cable protection apparatus (e.g., cable protection apparatus 1000). Put another way, the channel 2352 (also sometimes called a collet channel 2352 herein) has a default width (when the collet 2350 is not subject to a compressive force), and the channel 2352 may be configured to receive a cable (e.g., cable 1715) having a diameter (e.g., width 1716) within a range of diameters (or widths) that is less than the default width of the channel 2352 when the body 2351 (also sometimes called a collet body 2351 herein) is in the default state. As such, the width of the channel 2352 may be substantially the same as, or larger than, the height 1437 of the channel 1432 of the portion 1435 and/or the height 1537 of the channel 1532 of the portion 1535.

The body has a total of nine compression features 2353. Compression feature 2353-1, compression feature 2353-3, compression feature 2353-5, compression feature 2353-7, and compression feature 2353-9 begin at the wide (e.g., proximal) end of the body 2351 and terminate toward (but short of) the narrow (e.g., distal) end of the body 2351. Compression feature 2353-2, compression feature 2353-4, compression feature 2353-6, and compression feature 2353-8 begin at the narrow end of the body 2351 and terminate toward (but short of) the wide end of the body 2351.

In this case, all of the compression features 2353 of the body 2351 of the collet 1050 are in the form of slots that traverse the thickness of the body 2351. Each compression feature 2353 has a length that is less than the length 2359 of the body 2351. Also, all of the compression features 2353 of the body 2351 are arranged in parallel with and are spaced equidistantly from each other. Further, the various characteristics (e.g., length, width) of all of the compression features 2353 in this case are substantially the same as each other. The inner surface of the body 2351 forms a bore 2354 that extends along the entire length 2359 of the body 2351.

Example embodiments can be used to provide targeted protection to lengthwise portions of a cable (e.g., a wireline, an electrical cable) during a field operation (e.g., a wireline operation, a cable pulling operation). Example embodiments can be installed and securely placed in a secured position in a negligible amount of time, imposing only minimal delays in the field operation. Conversely, example embodiments can be returned to a default position and uninstalled in a negligible amount of time, imposing only minimal delays in retrieving a cable. Example embodiments can be installed, adjusted, manipulated, and/or uninstalled without the use of tools. Example embodiments may be configured to allow a damaged part to be replaced. Example embodiments may be configured to a single use or multiple uses. Example embodiments may comply with applicable industry standards when used during field operations.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A cable protection apparatus comprising:
a collet comprising a collet body and a collet bore, wherein the collet body has a collet length, wherein the collet bore traverses through the collet body along the collect length, wherein the collet body is radially compressible along the collet length, wherein the collet body has a compressed state and a default state, wherein the collet bore has a reduced collet diameter when the collet body is in the compressed state, and wherein the collet bore has a default collet diameter when the collet body is in the default state; and
an enclosure comprising an enclosure body, an enclosure bore, an enclosure channel, and an adjustment feature, wherein the enclosure bore traverses through the enclosure body along an enclosure length, wherein the enclosure channel traverses a thickness of the enclosure body to the enclosure bore along the enclosure length, wherein the enclosure bore traverses a receiving chamber disposed within the enclosure body, wherein the receiving chamber is configured to receive the collet, wherein the adjustment feature manipulates the enclosure body between an engaged position and a disengaged position, wherein the enclosure body applies a compressive force via the receiving chamber sufficient to put the collet body in the compressed state when the adjustment feature is in the engaged position, and wherein the enclosure body fails to apply the compressive force via the receiving chamber to the collet body when the adjustment feature is in the disengaged position to allow the collet body to be in the default state.

2. The cable protection apparatus of claim 1, further comprising:
a sleeve disposed over a portion of the enclosure.

3. The cable protection apparatus of claim 2, wherein the sleeve has an outer surface that is wear resistant.

4. The cable protection apparatus of claim 2, wherein the sleeve is movable relative to the enclosure when the sleeve is disposed over the portion of the enclosure.

5. The cable protection apparatus of claim 1, wherein the enclosure comprises a first portion movably coupled to a second portion.

6. The cable protection apparatus of claim 5, wherein the first portion comprises a first distal end and a first collar, wherein the second portion comprises a second distal end and a second collar, wherein the adjustment feature comprises complementary mating threads disposed on the first collar and the second collar, and wherein the enclosure channel lacks continuity between the first portion and the second portion when the enclosure is in the engaged position using the complementary mating threads.

7. The cable protection apparatus of claim 6, wherein the first distal end and the second distal end are conically shaped.

8. The cable protection apparatus of claim 7, wherein the first portion and the second portion are configured to be rotatably coupled to each other using the complementary mating threads without use of a tool.

9. The cable protection apparatus of claim 7, wherein the first distal end of the first portion and the second distal end of the second portion have outer surfaces that are wear resistant.

10. The cable protection apparatus of claim 7, wherein the first distal end of the first portion further comprises a tightening feature disposed on its outer surface, and wherein the tightening feature is configured to be engaged by a tool to secure the enclosure in the engaged position.

11. The cable protection apparatus of claim 1, wherein the receiving feature of the enclosure bore has a shape and a size that are configured to complement the collet body.

12. The cable protection apparatus of claim 1, wherein the collet further comprises a collet channel that traverses a thickness of the collet body to the collet bore along the collet length, wherein the collet channel has a default collet width, and wherein the collet channel is configured to receive a cable having a diameter within a range of diameters that is less than the default collet width when the collet body is in the default state.

13. The cable protection apparatus of claim 1, wherein the collet further comprises a first piece and a second piece that are configured to abut against each other to form the collet bore.

14. The cable protection apparatus of claim 13, wherein the first piece and the second piece are configured identically to each other.

15. The cable protection apparatus of claim 1, wherein the default collet diameter of the collet bore is configured to receive a cable having a diameter within a range of diameters when the collet body is in the default state, and wherein the reduced collet diameter of the collet bore is configured to apply an additional compressive force, derived from the compressive force applied by the enclosure to the collet, against the cable when the collet body is in the compressed state.

16. The cable protection apparatus of claim 1, wherein the collet further comprises a plurality of slots, wherein each slot of the plurality of slots traverses a thickness of the collet body and has length that is less than the collet length of the collet.

17. The cable protection apparatus of claim 1, wherein the adjustment feature is configured to keep the enclosure body in an engaged position until the adjustment feature is purposely acted upon.

18. A cable protection apparatus assembly comprising:
a cable having a cable thickness; and
a cable protection apparatus encasing a portion of the cable, the cable protection apparatus comprising:
a collet comprising a collet body and a collet bore, wherein the collet body has a collet length, wherein the collet bore traverses through the collet body along the collect length, wherein the collet body is radially compressible along the collet length, wherein the collet body has a compressed state and a default state, wherein the collet bore has a reduced collet diameter that is no greater than the cable thickness when the collet body is in the compressed state, and wherein the collet bore has a default collet diameter that is no less than the cable thickness when the collet body is in the default state; and
an enclosure comprising an enclosure body, an enclosure bore, an enclosure channel, and an adjustment feature, wherein the enclosure bore traverses through the enclosure body along an enclosure length, wherein the enclosure channel traverses a thickness of the enclosure body to the enclosure bore along the enclosure length, wherein the enclosure bore traverses a receiving chamber disposed within the enclosure body, wherein the receiving chamber is configured to receive the collet, wherein the adjustment feature manipulates the enclosure body between an engaged position and a disengaged position, wherein the enclosure body applies a compressive force via the receiving chamber sufficient to put the collet body in the compressed state when the adjustment feature is in the engaged position, and wherein the enclosure body fails to apply the compressive force via the receiving chamber to the collet body when the adjustment feature is in the disengaged position to allow the collet body to be in the default state.

19. The cable protection apparatus assembly of claim 18, wherein the cable comprises a wireline used in a subterranean wellbore.

20. The cable protection apparatus assembly of claim 18, wherein the cable comprises an electrical cable being pulled through a structure.
